(19) United States
(12) Patent Application Publication
(10) Pub. No.: US 2023/0245160 A1
(43) Pub. Date: Aug. 3, 2023

(54) SYSTEM AND METHOD FOR REWARDS CARDS OPTIMIZATION

(71) Applicant: CITADEL ENTERPRISE IP HOLDINGS LP, Miami, FL (US)

(72) Inventors: Scott Thurston Rickard, JR., Chicago, IL (US); David Alexander Sukhin, Watchung, NJ (US)

(21) Appl. No.: 17/589,700

(22) Filed: Jan. 31, 2022

(51) Int. Cl. G06Q 30/02; G06Q 30/06

(52) U.S. Cl. CPC G06Q 30/0233; G06Q 30/0269; G06Q 30/0224; G06Q 30/0601

(57) ABSTRACT

The following relates generally to determining an optimal rewards program (e.g., of a credit card or debit card), and purchasing one or more items via the optimal rewards program. In some embodiments, a cardholder initiates a first user-initiated interaction between a bank card and a bank card machine, which generates a first purchase authorization request. One or more processors of a first bank then determine an optimal rewards program for the purchase, and then decline the first purchase authorization request. The cardholder may then initiate a second user-initiated interaction between the bank card and the bank card machine, which generates a second purchase authorization request. One or more processors of a second bank (e.g., a bank of the rewards program) may then authorize the second purchase authorization request. Alternatively, some embodiments complete a purchase according to a determined optimal rewards program with only one user-initiated interaction.

### BACKGROUND

Currently, credit card holders are offered an abundance of choices among credit card rewards programs. Quickly selecting the best card to maximize rewards can be challenging due to the large number of potential rewards programs to use, and to the nuances between rewards programs. Moreover, current attempts to develop systems to allow users to select between credit card rewards programs have faced technical challenges.

The systems and methods disclosed herein provide solutions to these problems and others.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, a computer-implemented method may be provided. The method may comprise: receiving, with one or more processors, first data generated from a first user-initiated interaction between a bank card and a bank card processing machine, the first data including: (i) identification data identifying a cardholder of the bank card, and (ii) a first purchase authorization request to purchase one or more items from a merchant; identifying, with the one or more processors, based on the identification data, a plurality of rewards programs that the cardholder is enrolled in; determining, with the one or more processors, an optimal rewards program of the plurality of rewards programs for the purchase of the one or more items; declining, with the one or more processors, the first purchase authorization request to purchase the one or more items from the merchant; receiving, with the one or more processors, second data generated from a second user-initiated interaction between the bank card and the bank card processing machine, the second data including a second purchase authorization request to purchase the one or more items from the merchant; and completing, with the one or more processors, a purchase of the one or more items from the merchant by applying a payment method associated with the determined optimal rewards program to the second purchase authorization request to purchase the one or more items from the merchant.

In another aspect, a computer-implemented method may be provided. The method may comprise: receiving, with one or more processors, first data generated from a first user-initiated interaction between a bank card and one or more merchant processors, the first data including: (i) identification data identifying a cardholder of the bank card, and (ii) a first purchase authorization request to purchase one or more items from a merchant; identifying, with the one or more processors, based on the identification data, a plurality of rewards programs that the cardholder is enrolled in; determining, with the one or more processors, an optimal rewards program of the plurality of rewards programs for the purchase of the one or more items; declining, with the one or more processors, the first purchase authorization request to purchase the one or more items from the merchant; receiving, with the one or more processors, second data generated from a second user-initiated interaction between the bank card and the one or more bank card processors, the second data including a second purchase authorization request to purchase the one or more items from the merchant; and completing, with the one or more processors, a purchase of the one or more items from the merchant by applying a payment method associated with the determined optimal rewards program to the second purchase authorization request to purchase the one or more items from the merchant.

In yet another aspect, a computer-implemented method may be provided. The method may comprise: receiving, with one or more processors of a first bank, transaction data generated from a user-initiated interaction between a bank card and a bank card processing machine, the transaction data including: (i) identification data identifying a cardholder of the bank card, and (ii) a purchase authorization request to purchase one or more items from a merchant; identifying, with the one or more processors of the first bank, based on the identification data, a plurality of rewards programs that the cardholder is enrolled in; determining, with the one or more processors of the first bank, an optimal rewards program of the plurality of rewards programs for the purchase of the one or more items; and sending, with the one or more processors of the first bank, instructions to a second bank to send payment for the one or more items to the first bank, the second bank being a bank of the optimal rewards program.

In yet another aspect, a computer-implemented method may be provided. The method may comprise: receiving, with one or more processors of a first bank, transaction data generated from a user-initiated interaction between a bank card and one or more merchant processors, the transaction data including: (i) identification data identifying a cardholder of the bank card, and (ii) a purchase authorization request to purchase one or more items from a merchant; identifying, with the one or more processors of the first bank, based on the identification data, a plurality of rewards programs that the cardholder is enrolled in; determining, with the one or more processors of the first bank, an optimal rewards program of the plurality of rewards programs for the purchase of the one or more items; authorizing, with the one or more processors of the first bank, the request to purchase the one or more items from the merchant; and instructing, with the one or more processors of the first bank, a second bank to send payment for the one or more items to the first bank, the second bank being a bank of the optimal rewards program.

In yet another aspect, a system may be provided. The system comprise: a bank card processing machine configured to interact with a bank card to process a transaction; and one or more processors. The one or more processors may be configured to: receive first data generated from a first user-initiated interaction between the bank card and the bank card processing machine, the first data including: (i) identification data identifying a cardholder of the bank card, and (ii) a first purchase authorization request to purchase one or more items from a merchant; identify, based on the identification data, a plurality of rewards programs that the cardholder is enrolled in; determine an optimal rewards program of the plurality of rewards programs for the purchase of the one or more items; decline the first purchase authorization request to purchase the one or more items from the merchant; receive second data generated from a second user-initiated interaction between the bank card and the bank card processing machine, the second data including a second purchase authorization request to purchase the one or more items from the merchant; and complete a purchase of the one or more items from the merchant by applying a payment method associated with the determined optimal rewards program to the second purchase authorization request to purchase the one or more items from the merchant.

Some embodiments of the systems and methods disclosed herein advantageously reduce the number of electronic funds transfers (EFTs) from two EFTs to one EFT. As will become apparent upon reading this disclosure, this reduction in EFTs has the technical advantage that less signals must be sent through the system, and less data must be processed to complete a transaction.

### BRIEF DESCRIPTION OF THE DRAWINGS

FIG. 1 shows an example system in accordance with the principles disclosed herein.

FIG. 2 illustrates an example of a bank card.

FIG. 3 illustrates an example bank card machine.

FIG. 4 illustrates an example WiFi access point.

FIG. 5 illustrates an example Bluetooth beacon.

FIG. 6 illustrates an example signal diagram including completing a purchase with an optimal rewards program via two user-initiated interactions.

FIG. 7 illustrates an example screen of a mobile device for specifying a points-to-currency conversion rate.

FIG. 8 illustrates an example screen of a mobile device for specifying a default bank card, and for specifying preferences for selecting an optimal rewards program for a particular purchase.

FIG. 9 illustrates an example signal diagram including completing a purchase with an optimal rewards program via one user-initiated interaction.

FIG. 10 illustrates an example flow diagram including completing a purchase with an optimal rewards program via one user-initiated interaction.

FIG. 11 illustrates an example flow diagram including completing a purchase with an optimal rewards program via two user-initiated interactions.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present embodiments relate to, among other things, technical systems for selecting between rewards programs (e.g., rewards programs for a bank card, such as a credit card or debit card).

For example, a user (e.g., a cardholder) may have multiple credit cards with associated rewards programs, but it may be cumbersome to determine and use the best card to use for a particular purchase. Even when a user determines which card is best, it is not always easy to apply the desired payment method (e.g., it is cumbersome for a user to always be carrying numerous bank cards). Moreover, current systems for selecting between credit cards (e.g., electronic wallets) present technical challenges, as will be discussed further below.

For clarity in understanding, as used herein, the term “currency” refers to the currency of a country (e.g., dollars, euros, yuan, yen, etc.), and does not refer to “points” of a rewards program.

Furthermore, as used herein, the term “items” (e.g., as in the phrase “purchase of the one or more items”) may refer to physical, tangible items; however, additionally or alternatively, this term may refer to services (e.g., any type of services, such as medical services, dental services, etc.).

### Example Infrastructure

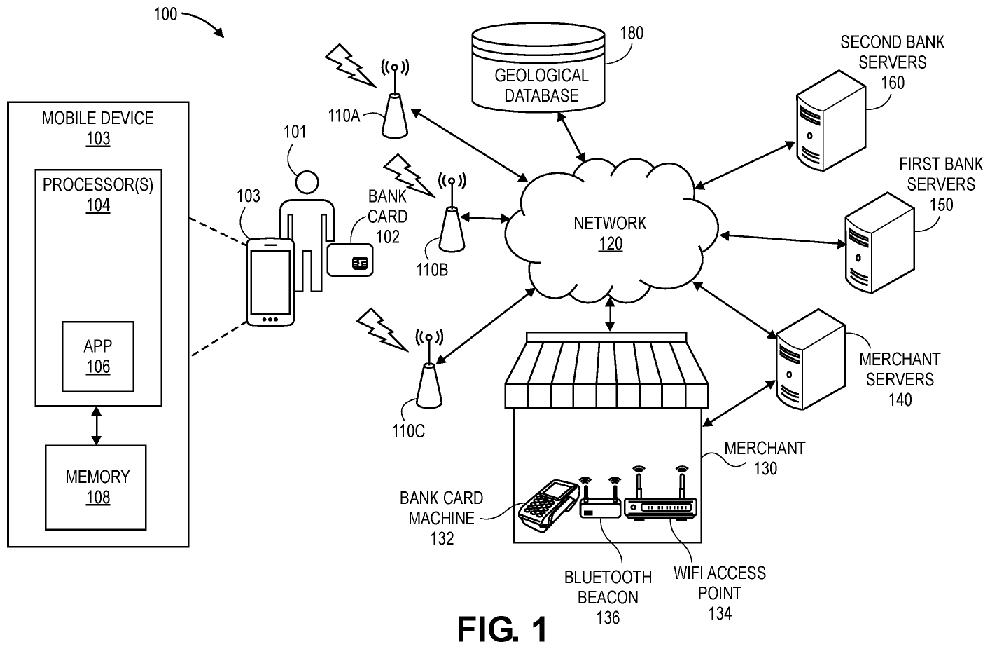

FIG. 1 shows an example system 100 in accordance with the principles described herein. With reference thereto, cardholder 101 may be a prospective purchaser of one or more items from merchant 130. To purchase the one or more items, the cardholder 101 may use bank card 102 (e.g., a credit card or debit card), or any other suitable device or method.

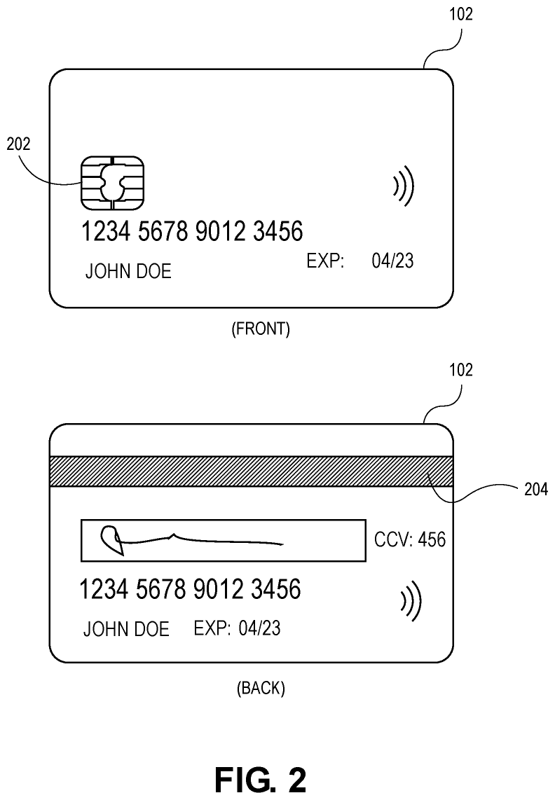

As illustrated in FIG. 2, the bank card 102 may be a physical bank card 102 including embedded microchip 202, such as an EMV chip. The microchip 202 may encrypt information when making transactions with merchants (or terminals, automated teller machines (ATMs), etc.) to increase data security. The microchip 202 may also include information regarding the account or accounts corresponding to the bank card 102 (including the corresponding rewards programs). As will become apparent from the following disclosure, in some embodiments, the bankcard 102 is a placeholder card that may be used to facilitate a transaction via any bankcard of a rewards program that the cardholder 101 is enrolled in.

In some embodiments, to initiate a transaction, the cardholder 102 inserts the bank card 102 into a bank card machine, such as bank card machine 132 (e.g., to enable the transaction through the microchip 202). Additionally or alternatively, the bank card 102 may have a magnetic stripe 204. As such, in some embodiments, the cardholder 101 swipes the bank card 102 in the bank card machine 132 to initiate a transaction. Additionally or alternatively, to initiate a transaction, the cardholder 101 may tap the bank card 102 with the bank card machine 132 (e.g., to initiate the transaction via near field communication (NFC)). In some embodiments, the cardholder must also enter a personal identification number (PIN) after inserting or swiping the card 102 to complete a transaction.

Returning to FIG. 1, the cardholder 102 may also have a mobile device 103 (e.g., a mobile phone, a tablet, laptop, phablet, etc.). The mobile device may include a processor 104 (which may also be referred to as a microcontroller or a microprocessor). Although the example of FIG. 1 illustrates only one processor, it should be understood that the mobile device 103 may include any number of processors 104. The processor 104 may be adapted or configured to execute an application (app) 106 (e.g., an electronic wallet app, or an app for selecting between rewards programs in accordance with the techniques described herein, etc.). As illustrated, the mobile device 103 may further include a memory 108 coupled to the processor 104. The processor 104 may interface with the memory 108 via a computer bus to execute an operating system (OS) on the mobile device 103.

The mobile device 103 may be connected to the computer network 120, which may comprise a packet based network operable to transmit computer data packets among the various devices and servers described herein. For example, computer network 120 may include any one or more of Ethernet based network, a private network, a local area network (LAN), and/or a wide area network (WAN), such as the Internet. In addition, in some embodiments, computer network 120 may comprise cellular or mobile networks to facilitate data packet traffic (e.g., mobile device movement data) to and from base stations 110a, 110b, 110c.

Base stations 110a, 110b, 110c may comprise cellular towers or access points implementing any one or more cellular or mobile device standards, including, for example, any of GSM, UMTS, CDMA, NMT, LTE, 5G NR, 6G or the like. In some embodiments, the mobile device 103 is connected to the network 120 through only one of the base stations 110a, 110b, 110c. Yet, in other embodiments, the mobile device 103 is connected to the network 120 through more than one of the base stations 110a, 110b, 110c, which, as will be further described below, allows determination of the location of the mobile device 103 through triangulation.

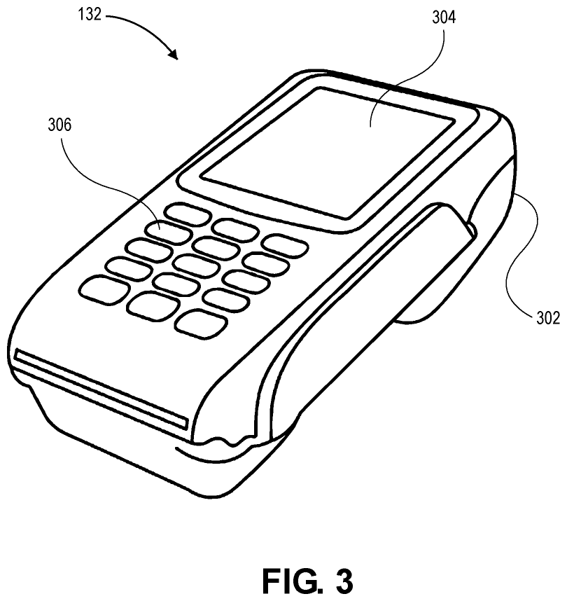

In some embodiments, the cardholder 101 may shop for the one or more items to purchase at the merchant 130 (e.g., a physical, “brick and mortar” store of the merchant). The merchant 130 may, in addition to items for purchase, have a bank card machine 132, and an example of which is illustrated in FIG. 3. The bank card machine 132 may be comprised of a housing 302, which may be plastic or any other suitable material. The bank card machine 132 may further have a screen 304 (which may or may not be a touchscreen), and/or keypad 306 (which may be a physical keypad or may be part of the touchscreen. The bank card machine 132 may further include one or more processors and memories.

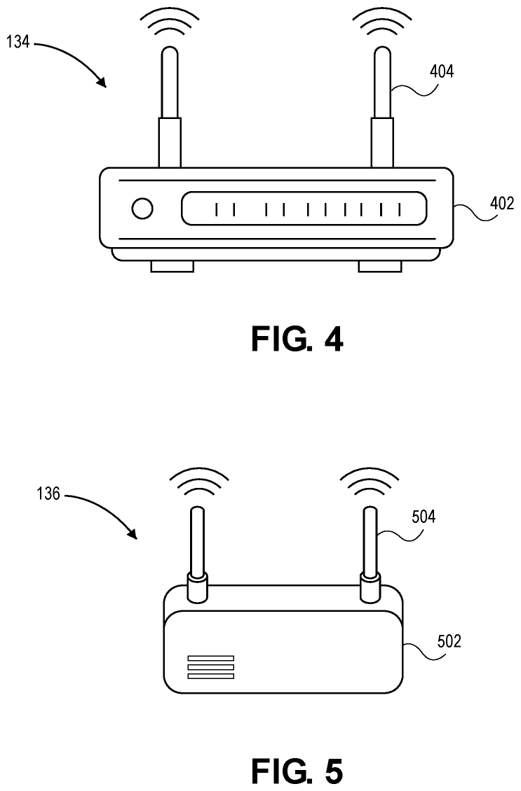

The merchant 130 may further include a WiFi access point 134. The WiFi access point 134 may be comprised of a housing 402, which may be plastic or any other suitable material. The WiFi access point 134 may further have one or more antennas 404 for wireless communication, such as for communication with the mobile device 103. The WiFi access point 134 may further include one or more processors and memories. An example of the WiFi access point 134 is illustrated in the example of FIG. 4.

The merchant 130 may further include a Bluetooth beacon 136, which may be used for communication with the mobile device 103. For example, Bluetooth beacon 136 may send a packet of information containing a Universally Unique Identifier (UUID) to the mobile device 103. The UUID may then trigger an event on the mobile device 103. For instance, the UUID may interact with an app on the mobile device 103 to produce a push notification with an advertisement for the merchant 130 or for a product sold by the merchant 130. In addition, the Bluetooth beacon 136 may receive information from the mobile device 103 identifying the mobile device 103.

Further, the Bluetooth beacon 136 may be used to determine the location of the mobile device 103. To this end, when information (e.g., including identity information) is received from the mobile device 103 at the Bluetooth beacon 136, an approximate location of the mobile device 103 may be known simply from a known location of the Bluetooth beacon 136. In addition, there may be multiple Bluetooth beacons 136, and trilateration may be used to determine a more precise location of the mobile device 103. For example, the merchant 130 may be located in a mall, and the Bluetooth beacons 136 may be used to effectively determine the location of the cardholder 101 walking, through the mall, from merchant to merchant.

As illustrated in the example of FIG. 5, the Bluetooth beacon 136 may be comprised of a housing 502, which may be plastic or any other suitable material. The Bluetooth beacon 136 may further have one or more antennas 504 for wireless communication, such as for the communication discussed above with the mobile device 103. The Bluetooth beacon 136 may further include one or more processors and memories.

Returning to the example of FIG. 1, the merchant 130 may own merchant servers 140. The merchant servers 140 may be located in the same physical building as a store of the merchant 130 or in a different physical building. Additionally or alternatively, the merchant servers 140 may be part of a cloud computing arrangement. The merchant servers 140 may send/receive data to/from any of the components of the merchant 130, such as the bank card machine 132, the WiFi access point 134 and/or the Bluetooth beacon 136. Additionally or alternatively, the merchant servers 140 may comprise servers of a bank of the merchant 130. The merchant servers 140 may include one or more processors and memories.

The example system 100 may further include first bank servers 150. The first bank servers 150 may correspond to a first bank or other financial and/or technological institution. The first bank servers 150 may include one or more processors and memories, and may store user data, such as user data of the cardholder 101. The first bank servers may also store data of merchants, such as the merchant 130.

Further illustrated in the example is second bank servers 160. The second bank servers 160 may correspond to a second bank or other financial and/or technological institution. The second bank servers 160 may include one or more processors and memories, and may store user data, such as user data of the cardholder 101. The second bank servers may also store data of merchants, such as the merchant 130. As will be further explained below, transactions may be conducted between the first bank servers 150 and the second bank servers 160.

Still further illustrated is geolocation database 180, which may store any kind of information, including geolocation information. The geolocation information may include geo-fences for stores, such as a store of the merchant 130. As will be explained further below, the geolocation information may be leveraged to determine a merchant that a transaction is occurring at. The geolocation database 180 may include one or more processors and memories.

### Example Techniques—Completing a Purchase Via Two User-Initiated Interactions

Some embodiments advantageously allow for a cardholder to use an optimal rewards program to maximize rewards for making a purchase.

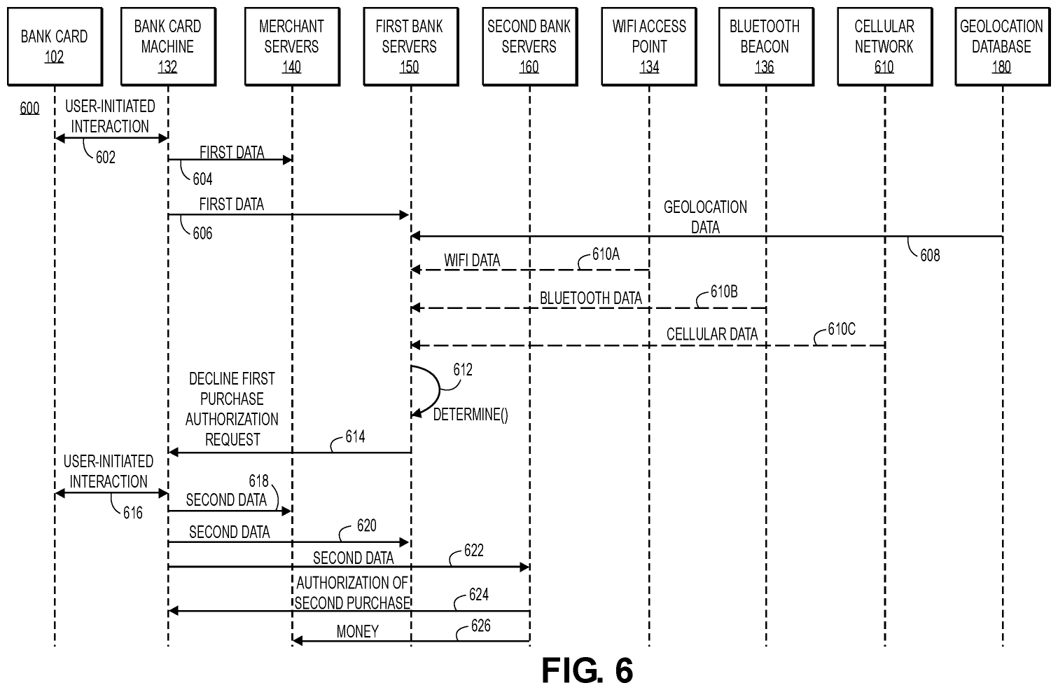

To this end, FIG. 6 illustrates an example signal diagram for completing a purchase with an optimal rewards program via two user-initiated interactions. The signal diagram 600 begins when there is a first user-initiated interaction (602) between the bank card 102 and the bank card machine 132. For instance, for the first user-initiated interaction, to purchase one or more items from the merchant 130, the cardholder 101 (e.g., the user) may swipe the bank card 102 in the bank card machine 132. Additionally or alternatively, as the first user-initiated interaction, the cardholder 101 may insert the bank card 102 including the microchip 202 (e.g., an EMV microchip) into the bank card machine 132. Additionally or alternatively, as the first user-initiated interaction, the cardholder 101 may tap the bank card 102 with the bank card machine 132 (e.g., to make the first user-initiated interaction via NFC).

Additionally or alternatively, the first user-initiated interaction may be made via an interaction between the mobile device 103 (e.g., by using an electronic wallet of the mobile device 103, or by any other suitable technique) and the bank card machine 132. Additionally or alternatively, the first user initiated interaction may be with a website of the merchant 130 rather than the bank card machine 132 (although the website is not illustrated in the example of FIG. 6). To this end, the merchant website may be run from the merchant servers 140 (or from one or more merchant processors thereof), or from any other suitable source. Additionally or alternatively, a browser extension (or one or more processors of a browser extension) may be used to initiate the purchase and/or select the optimal rewards program. To this end, the browser extension may be installed on a computing device of a user (e.g., a laptop, personal computer, tablet, smartphone, etc.).

The first user-initiated interaction may generate first data. For example, the generated first data may include: (i) identification data identifying the cardholder 101 of the bank card 102, (ii) a first purchase authorization request to purchase the one or more items from the merchant 130, (iii) merchant identification data, and/or (iv) any other information of the transaction (e.g., description including price of the one or more items, etc.). The generated first data may then be sent (604, 606) to the merchant servers 140 and the first bank servers 150. This first data may be used to determine an optimal rewards program for the purchase of items of the first user-initiated interaction.

However, in some embodiments, to make the determination of which rewards program is optimal, it is useful to know the identity of the merchant 130 (e.g., some rewards programs grant rewards only to particular merchants, or only to particular types of merchants, etc.). Sometimes, the first bank servers 150 may determine the merchant identity from the received first data (e.g., if merchant identification data is included in the first data). Yet, merchant identification data is not always included in the first data (or information which allows only a partial identification of the merchant is included). As such, determining the identity of the merchant 130 is often technically challenging (e.g., when merchant identification data is not readily accessible). In this regard, the following techniques described herein provide a technical solution to this technical challenge of merchant identification based on only a limited amount of data. More specifically, and as will be explained further below, some embodiments leverage geolocation data (e.g., of geolocations of merchants) with location data of the mobile device 103 to determine where a transaction, such as the first user-initiated transaction 602, is occurring.

In this respect, in some embodiments, the first bank servers receive (608) geolocation data from the geolocation database 180. The geolocation data may include a map with geo-fences illustrating the locations of stores, such as of a store of the merchant 130. If the location of the cardholder 101 is known at the time of the first user-initiated transaction (e.g., by knowing the location of the mobile device 103), the cardholder location may be used along with the received geolocation data to determine the identity of the merchant 130.

Any suitable technique may be used to determine the location of the cardholder 101. For example, the first bank servers may receive (610a) WiFi data (e.g., directly or indirectly) from WiFi access point 134. For instance, the WiFi access point 134 may acquire data of the mobile device 103 because the mobile device is connected to a WiFi network through the WiFi access point 134. The data acquired by the WiFi access point 134 may include identity data of the mobile device 103 or any other data. Furthermore, the mobile device 103 does not necessarily have to be connected to a WiFi network of the WiFi access point 134 for the WiFi access point 134 to collect data of the mobile device 103. Moreover, the WiFi access point 134 may also send its own location data to the first bank servers 150. Additionally or alternatively, the geolocation data sent at 608 may include location data of the WiFi access points 134.

Additionally or alternately to receiving the WiFi data, the first bank servers 150 may receive (610b) Bluetooth data (e.g., directly or indirectly) from the Bluetooth beacon 136. For instance, the Bluetooth beacon 136 may acquire data of the mobile device 103 by the Bluetooth beacon 136 sending a request for information to the mobile device 103, and the mobile device 103 responding to the request. In some embodiments, mobile device 103 has preset settings allowing the cardholder 101 to set whether or not the mobile device responds to the request. Additionally or alternatively, the Bluetooth beacon 136 may send a packet of information containing a UUID to the mobile device 103, which may then trigger an event on the mobile device 103. For instance, the UUID may interact with an app on the mobile device 103 to produce a push notification with an advertisement for the merchant 130 or for a product sold by the merchant 130. Through these interactions, the mobile device 103 may send data back to the Bluetooth beacon 136.

Furthermore, when information (e.g., including identity information) is received from the mobile device 103 at the Bluetooth beacon 136, an approximate location of the mobile device 103 may be known simply from a known location of the Bluetooth beacon 136. In addition, there may be multiple Bluetooth beacons 136, and trilateration may be used to determine a more precise location of the mobile device 103. For example, the merchant 130 may be located in a mall, and the Bluetooth beacons 136 may be used to effectively determine the location of the cardholder 101 walking, through the mall, from merchant to merchant.

In addition, the first bank servers 150 may receive (610c), from the cellular network 610, data gathered from the base stations 110a, 110b, 110c. The received data may allow for location determination of mobile device 103 through triangulation. For example, while the base stations 110a, 110b, 110c are communicating with the mobile device 103, the base stations 110a, 110b, 110c (or cellular network 610) may measure the time delay that a signal takes to return back to the base stations 110a, 110b, 110c. The measured time delay yields an approximate distance to each base station 110a, 110b, 110c; and, from the approximate distances, an approximate location of the mobile device 103 may be determined. The location calculation may be done by any suitable component (e.g., by the cellular network 610, first bank servers 150, etc.).

Moreover, it should be understood that any of the above-described location techniques (e.g., through WiFi, Bluetooth, or cell phone triangulation) may be combined.

Returning to the example of FIG. 6, subsequent to the receipt of the information at 610a, 610b, 610c, the first bank servers 150 may determine (612) an optimal rewards program (e.g., corresponding to a credit or debit card of the cardholder 101) for purchase of the one or more items by the cardholder 101. For example, the first bank servers 150 may begin this by determining a list of rewards programs that the cardholder 101 is enrolled in. The first bank servers 150 may then calculate rewards for each rewards program. In this regard, when determining the optimal rewards program, the first bank servers 150 also determine servers corresponding to the optimal rewards program (e.g., second bank servers 160).

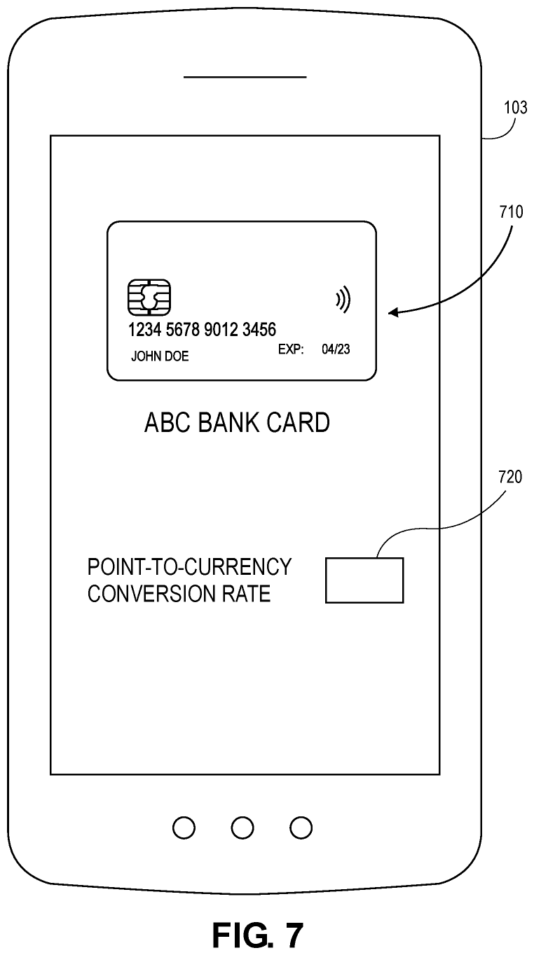

However, some rewards program grant rewards in currency, while others grant rewards in points. As such, in some embodiments, the first bank servers 150 convert points into an equivalent currency value (or convert the currency into points) in order to compare values to determine the optimal rewards program. To this end, the cardholder 101 may be allowed to specify a desired points-to-currency conversion rate. For instance, in the example of FIG. 7, the cardholder 101 may enter, in entry box 720, a points-to-currency conversion rate for rewards bank card 710. This may be part of an app (e.g., app 106) running on the mobile device 103. Moreover, it should be understood that the cardholder 101 may enter a points-to-currency conversion rate for each rewards card corresponding to a rewards program that he has. For example, the cardholder 101 may specify that each point on a first card is worth $1.1, and each point on a second card is worth $0.9.

Furthermore, as discussed above, it may be useful to know the identity of the merchant 103 when calculating the rewards that would be generated by a particular purchase (e.g., as part of determining the optimal rewards program). For example, some rewards programs grant extra rewards when purchasing from a particular merchant (e.g., extra rewards miles when purchasing airline tickets from a particular airline). In another example, some rewards programs grant extra rewards when purchasing a particular type of item (e.g., groceries, gas, fast food, travel, etc.). In some embodiments, the type of item may be determined from the merchant identity. For example, the purchase is from a gas station, so the item is determined to be gas; the purchase is from a grocery store, so the items are determined to be groceries; or the purchase is from a hotel or airline, so the items are determined to be travel, etc.

Additionally or alternatively, the rewards may be determined based on the type of the merchant. Examples of types of merchants include: grocery stores, convenience stores, gas stores, retail stores, home improvement stores, wholesale clubs, restaurants, fast food stores, hotels, travel companies, airlines, rental companies, repair shops, etc.

The type of merchant, in some embodiments, is determined from the merchant identity. To this end, the merchant identity may be determined by any suitable method. For example, the merchant identity may be determined from the merchant identification data (e.g., if it is included in the first data sent at 606).

Additionally or alternatively, as discussed above, the merchant identity may be determined from location data of the mobile device 103 and the geolocation data received at 608. For example, the location of the mobile device 103 may be determined by any of the techniques described above (e.g., through WiFi, Bluetooth, or cell phone triangulation). Then, the location may be cross referenced with the geolocation data which includes the locations of merchants. For instance, the geolocation data may include a map which includes geo-fences for stores of merchants. By cross referencing the geolocation data of the merchants with the location of the mobile device 103 at the time of the first user-initiated transaction 602, the first bank servers 150 are able to determine the identity of the merchant.

Additionally or alternately, the merchant identity may be determined based on the data included in the first purchase authorization request (e.g., included in the first data sent at 606). For example, the first purchase authorization request may include a transaction description. Then, the transaction description may be used with data of labeled descriptions which map transaction descriptions to merchants to determine the identity of the merchant. The data of labeled descriptions which map transaction descriptions to merchants may come from any suitable source. For instance, the servers of the first bank 150 may include a database of this data. Additionally or alternately, the data may come from an external database.

Additionally or alternatively to using the transaction description with the data of labeled descriptions which map transaction descriptions, the transaction description may be used with regular expression (regex) data mapping transaction descriptions to merchants. It should be understood that a regex may be a sequence of characters specifying a search pattern. Such patterns may be used by string-searching algorithms for “find” operations on strings, or for input validation. In this regard, the identity of the merchant 130 may be determined by applying the transaction description to the regrex data mapping transaction descriptions to merchants. The regrex data may come from any suitable source. For instance, the servers of the first bank 150 may include a data base of this data. Additionally or alternately, the data may come from an external database.

The identity of the merchant may, additionally or alternatively to the above-described techniques, be determined by applying the transaction description to a machine learning algorithm, such as a neural network. For example, a machine learning algorithm may be trained to identify a specific merchant based on the transaction description. However, to improve the effectiveness and accuracy of the machine learning algorithm, additional information may be used. The additional information may be sent at 606 or at any other suitable time. The additional transaction information may include: a transaction amount, a merchant category code (MCC), and/or a merchant address.

Furthermore, it should be understood that any suitable machine learning technique may be used. For example, a neural network, a deep learning algorithm, a reinforcement learning algorithm, a gradient boosting technique, etc., may be used.

The determination of the optimal rewards program may, additionally or alternatively to the above-described techniques, be done based on a minimum spend requirement of a rewards program. For instance, a rewards program may have a requirement to spend $1,000 in the first three months to receive 50,000 points. Such minimum spend requirements may be taken into account when determining the optimal rewards program.

Additionally or alternatively, a bidding process may be used to determine the optimal rewards program. For example, the servers of the first bank 150 may send the first information (e.g., including a description of the one or more items to be purchased) to one or more of the rewards programs the cardholder 101 is enrolled in. The rewards programs may then submit bids (e.g., in currency or rewards points) for the purchase. The servers of the first bank 150 may then select a bid from the submitted bids.

In this respect, even if only one bid is received back by the first bank servers 150, it may still be used. For example, the first bank servers 150 may compare this bid to amounts of rewards calculated from other rewards programs that did not participate in the bidding process.

Furthermore, in some embodiments, the bidding process happens in real time, and bids are final. For example, once the first bank servers 150 receive the bids, the first bank servers 150 may select a top bid, and the rewards programs do not have an opportunity to increase their bids.

Moreover, to compare bids between rewards programs, the above-described points-to-currency conversion technique may be used. For example, if the rewards program submits a bid in points, the first bank servers 150 may convert the bid to currency based on the user-specified points-to-currency conversion rates.

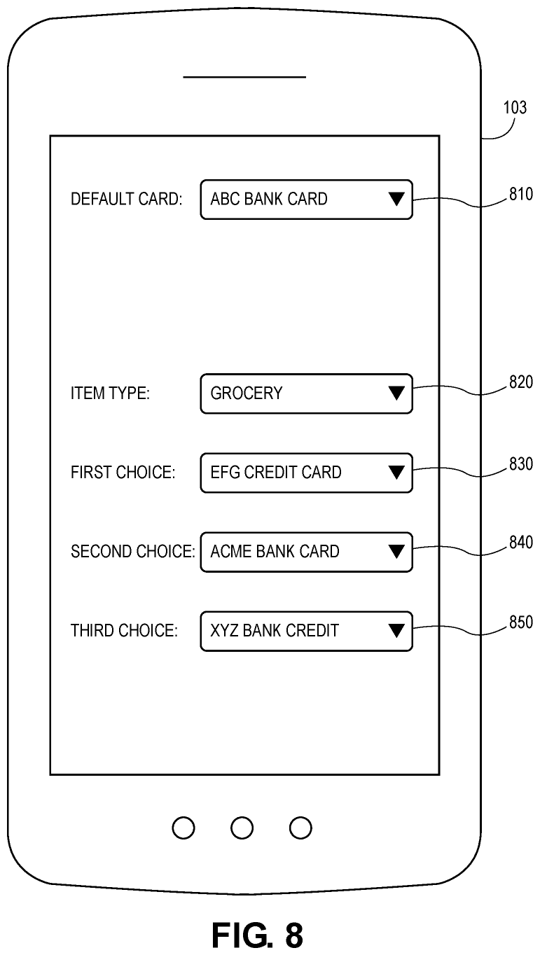

Additionally or alternatively, the optimal rewards program may be determined based on preferences specified by the cardholder 101. For instance, the user may specify a default preference for using a card (e.g., specify a default bank card). FIG. 8 illustrates an example of mobile device 103 accepting an input for a preference of a default bank card by a user typing or selecting from a dropdown arrow of the entry box 810.

In one example implementation, the cardholder 101 may specify a default rewards credit card; however, when the user attempts to make the purchase (e.g., through the first user-initiated interaction 602), the merchant 130 may not accept that particular type of credit card, so the first bank servers 150 will use a different card other than the default card. In this regard, the cardholder 101 may further specify an ordered list of bank cards to use.

Further regarding the preferences, the cardholder 101 may specify preferences that are rules for using cards. For instance, the cardholder 101 may specify that a particular bank card is to be used for a particular merchant, type of merchant, item to purchase, type of item to purchase, etc. For instance, as illustrated in the example of FIG. 8, a user may select an item type by inputting the item type or selecting the item type from a down arrow of entry box 820. Further in this example, the user may select first, second, and third choices for bank cards for purchasing items of the item type though the entry boxes 820, 830, 840 (e.g., by typing the card name or by selecting the card for a dropdown arrow, etc.).

Once the first bank servers 150 determine the optimal rewards program, the first bank servers 150 may decline (614) the first purchase authorization request. One technical reason for this is so that the next purchase authorization request may be directly routed to the second bank servers 160 (e.g., the servers corresponding to the determined optimal rewards program). Furthermore, along with the instruction to decline the first purchase authorization request, the first bank servers 150 may also send information of which rewards program (and corresponding bank card) was determined to be the optimal rewards program. That way, as will become apparent from the following discussion, the bank card machine 132, the merchant servers 140, the bank card 103, and/or the mobile device 103 will know where to route the second data, which will be discussed below.

In response to the declined request, the bank card machine 132 may indicate that the transaction has been declined. For instance, a screen 304 of the bank card machine 132 may indicate that the transaction has been declined; and, the bank card machine 132 may also send an audio alert that the transaction has been declined.

Further in response to the declined transaction, the cardholder 101 may initiate a second transaction 616. For example, the user may initiate the second transaction with the same bank card 102 as the first transaction was initiated with. Using the same physical bank card 102 advantageously simplifies the process for the cardholder 101 (e.g., the cardholder 101 does not need to search for a different bank card, such as different rewards card). Any suitable technique may be used to initiate the second transaction (e.g., swiping, inserting, taping, etc., as discussed above with respect to the first technique). As such, the technique for initiating the second transaction may be the same or different than the technique for initiating the first transaction.

The second user-initiated interaction may generate second data. For example, the generated second data may include: (i) identification data identifying the cardholder 101 of the bank card 102, (ii) a second purchase authorization request to purchase the one or more items from the merchant 130, (iii) merchant identification data, and/or (iv) any other information of the transaction (e.g., description including price of the one or more items, etc.). The generated second data may then be sent (618, 620, 622) to the merchant servers 140, the first bank servers 150, and the second bank servers 160 (the second bank servers 160 being, e.g., the servers of the bank of the optimal rewards program). This second data may be used (e.g., by the second bank servers 160) to complete the transaction.

The second bank servers 160 and/or the first bank servers 150 may identify that the second transaction corresponds to the first transaction. And this may be done by any suitable technique. For example, second bank servers 160 and/or the first bank servers 150 may identify that the one or more items are the same. Additionally or alternatively, the second bank servers 160 and/or the first bank servers 150 may use time stamp data to determine that the first and second user-initiated interactions were made within a predetermined time period.

However, in some embodiments, the second data is not sent directly from the bank card machine 132 to the second bank servers 160. Rather, the second data is first sent to the first bank servers 150, which in turn send it to the second bank servers 160.

In response to receiving the second data (including, e.g., the second purchase authorization request), the second bank servers 160 may authorize the transaction so that the purchase is completed. To this end, the second bank servers 160 may send 624 the authorization to the bank card machine 132. The second bank servers 160 may then send 626 the money for the purchase (e.g., by an electronic funds transfer (EFT)) to the merchant servers 140 (e.g., to a bank of merchant 130). However, it may be noted that there is often a fee associated with such an EFT.

Furthermore, the example signal diagram 600 should be regarded as illustrative, and not restrictive. For example, additional events may be performed, and not all events are necessarily required to be performed. Further, the events do not necessarily have to be performed by the components illustrated. For example, some of the events may be performed by the first bank servers 150 may be performed by other servers, such as the merchant servers 140, or the second bank servers 160. In another example, rather than send data directly to the first bank servers 150, any of the WiFi access point 134, Bluetooth beacon 136, or cellular network 610 may send the data to the merchant servers 140 and/or bank card machine 132, which may in turn send the data to the first bank servers 150.

Moreover, the example signal diagram 600 applies to online purchases as well. For example, it should be understood that for online purchases, in the signal diagram 600, the bank card machine 132 is replaced with a website of a merchant, with the remainder of the signal diagram remaining substantially similar. However, it should be understood that for online purchases, it is not normally necessary to perform any of events 608, 610a, 610b, or 610c because the merchant identity is more easily ascertainable in an online transaction. For instance, the merchant identity may be obtainable from the first data generated from the first user-initiated interaction (the first user-initiated interaction being, e.g., the cardholder 101 attempting to purchase the one or more items from an online website with the card numbers of the bank card 102). In another example, in an online purchase, the identity of the merchant may also be determined from data of the website of the merchant (e.g., the website that the cardholder 101 is making the transaction from).

Further in this regard, for some embodiments involving online purchases, the determination (612) of the optimal rewards program and/or other events in the signal diagram 600 may be performed by a browser extension (e.g., by one or more processors of a browser extension). For instance, in some embodiments, each of the events of the signal diagram 600 performed by the first bank servers 150 may be performed by the browser extension. Advantageously, in some of these embodiments, much of the computation that might have been performed at the first bank servers 150 is instead performed at a computing device of a user (e.g., a laptop, personal computer, tablet, smartphone, etc.), thus saving computational resources at the first bank servers 150.

### Example Techniques—Completing a Purchase Via One User-Initiated Interaction

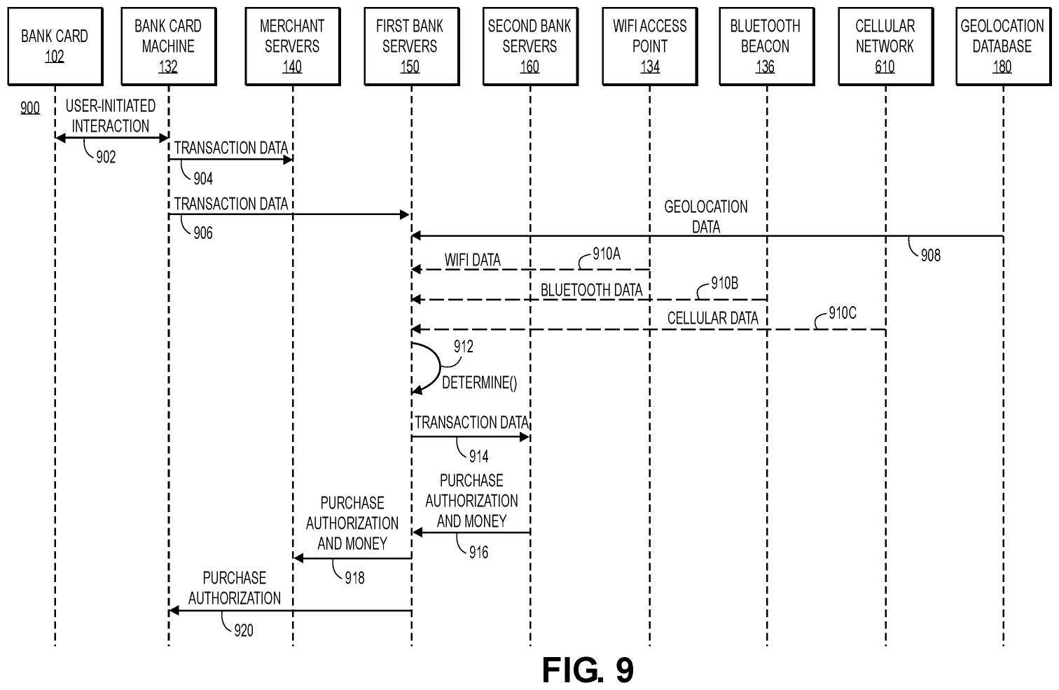

FIG. 9 illustrates an example signal diagram for completing a purchase with an optimal rewards program via one user-initiated interaction. The signal diagram 900 begins when there is a user-initiated interaction (902) between the bank card 102 and the bank card machine 132. For instance, for the user-initiated interaction, to purchase one or more items from the merchant 130, the cardholder 101 (e.g., the user) may swipe the bank card 102 in the bank card machine 132. Additionally or alternatively, as the user-initiated interaction, the cardholder 101 may insert the bank card 102 including the microchip 202 (e.g., an EMV microchip) into the bank card machine 132. Additionally or alternatively, as the user-initiated interaction, the cardholder 101 may tap the bank card 102 with the bank card machine 132 (e.g., to make the first user-initiated interaction via NFC).

Additionally or alternatively, the user-initiated interaction may be made via an interaction between the mobile device 103 (e.g., by using an electronic wallet of the mobile device 103, or by any other suitable technique) and the bank card machine 132. Additionally or alternatively, the user initiated interaction may be with a website of the merchant 130 rather than the bank card machine 132 (although the website is not illustrated in the example of FIG. 9). To this end, the merchant website may be run from the merchant servers 140 (or from one or more merchant processors thereof), or from any other suitable source. Additionally or alternatively, a browser extension (e.g., by one or more processors of a browser extension) may be used to initiate the purchase and/or select the optimal rewards program. To this end, the browser extension may be installed on a computing device of a user (e.g., a laptop, personal computer, tablet, smartphone, etc.).

The user-initiated interaction may generate transaction data. For example, the generated transaction data may include: (i) identification data identifying the cardholder 101 of the bank card 102, (ii) a purchase authorization request to purchase the one or more items from the merchant 130, (iii) merchant identification data, and/or (iv) any other information of the transaction (e.g., description including price of the one or more items, etc.). The generated transaction data may then be sent (904, 906) to the merchant servers 140 and the first bank servers 150. This transaction data may be used to determine an optimal rewards program for the purchase of items of the user-initiated interaction.

However, in some embodiments, to make the determination of which rewards program is optimal, it is useful to know the identity of the merchant 130. Sometimes, the first bank servers 150 may determine the merchant identity from the received transaction data (e.g., if merchant identification data is included in the transaction data). Yet, merchant identification data is not always included in the transaction data (or information which allows only a partial identification of the merchant is included).

To this end, similarly as described with respect to FIG. 6, the identity of the merchant may be determined based on geolocation data (e.g., received at 908 by the first bank servers 150), WiFi data (e.g., received at 910a by the first bank servers 150), Bluetooth data (e.g., received at 910b by the first bank servers 150), and/or cellular data (e.g., received at 910c by the first bank servers 150). The identity of the merchant 130 may be determined by any other suitable technique as well.

The first bank servers 150 may then determine (912) an optimal rewards program (e.g., corresponding to a credit or debit card of the cardholder 101) for purchase of the one or more items by the cardholder 101. This may be done similarly as in 612 of FIG. 6.

Once the optimal rewards program has been determined, the first bank servers 150 send (914) the transaction data (including, e.g., the purchase authorization request) to the bank of the optimal rewards program (e.g., the second bank servers 160).

The second bank servers 160 may then determine whether or not to authorize the purchase. If the determination is made to authorize the purchase, the second bank servers 160 send (916) the purchase authorization along with the money (e.g., by an EFT) to the first bank servers 150. However, it may be noted that there is often a fee associated with such an electronic transfer of funds.

It may also be noted that in some embodiments, the determination of whether or not to authorize the purchase is done by the first bank servers 150 rather than the second bank servers 160. In some of these embodiments, the first bank servers 150 make this determination prior to sending the transaction data at 914.

Next, the first bank servers 150 send (918) the purchase authorization along with the money (e.g., by an EFT) to the merchant servers 140 (e.g., to a bank of merchant 130). Thus, the example of FIG. 9 includes two EFTs. However, it may be noted that embodiments involving only one EFT (e.g., the example of FIG. 6) have a technical advantage over embodiments involving two EFTs (e.g., the example of FIG. 9). In particular, reducing the number of EFTs means that less signals must be sent through the system, and less data must be processed to complete a transaction. Thus, less EFTs results in improved technical functioning.

In addition, it may again be noted that there is often a fee associated with such an electronic transfer of funds. Thus, some embodiments that involve two user-initiated interactions (and thus one EFT such as the example of FIG. 6) have a financial advantage over embodiments that involve only one user-initiated interaction (and thus two EFTs such as the example of FIG. 9) because they have only one EFT (and thus only one associated fee).

The transaction is completed by the first bank servers 150 sending (920) the purchase authorization to the bank card machine 132. In response, the bank card machine 132 may display that the purchase has been authorized on the screen 304.

Furthermore, the example signal diagram 900 should be regarded as illustrative, and not restrictive. For example, additional events may be performed, and not all events are necessarily required to be performed. Further, the events do not necessarily have to be performed by the components illustrated. For example, some of the events may be performed by the first bank servers 150 may be performed by other servers, such as the merchant servers 140, or the second bank servers 160. In another example, rather than send data directly to the first bank servers 150, any of the WiFi access point 134, Bluetooth beacon 136, or cellular network 610 may send the data to the merchant servers 140 and/or bank card machine 132, which may in turn send the data to the first bank servers 150.

Moreover, the example signal diagram 900 applies to online purchases as well. For example, it should be understood that for online purchases, in the signal diagram 900, the bank card machine 132 is replaced with a website of a merchant, with the remainder of the signal diagram remaining substantially similar. However, it should be understood that for online purchases, it is not normally necessary to perform any of events 908, 910a, 910b, or 910c because the merchant identity is more easily ascertainable in an online transaction. For instance, the merchant identity may be obtainable from the transaction data generated from the user-initiated interaction (the user-initiated interaction being, e.g., the cardholder 101 attempting to purchase the one or more items from an online website with the card numbers of the bank card 102). In another example, in an online purchase, the identity of the merchant may also be determined from data of the website of the merchant (e.g., the website that the cardholder 101 is making the transaction from).

Further in this regard, for some embodiments involving online purchases, the determination (912) of the optimal rewards program and/or other events in the signal diagram 900 may be performed by a browser extension (e.g., by one or more processors of a browser extension). For instance, in some embodiments, each of the events of the signal diagram 900 performed by the first bank servers 150 may be performed by the browser extension. Advantageously, in some of these embodiments, much of the computation that might have been performed at the first bank servers 150 is instead performed at a computing device of a user (e.g., a laptop, personal computer, tablet, smartphone, etc.), thus saving computational resources at the first bank servers 150.

In one example of this, the one or more processors of the browser extension may determine the optimal rewards program (e.g., according to any of the techniques described herein, such as those performed in other embodiments by the first bank servers 150), and send the transaction data including the purchase authorization request to the second bank servers 160; the second bank servers 160 may then authorize the transaction, and the transaction may be completed.

### Example Implementation—Completing a Purchase Via One User-Initiated Interaction

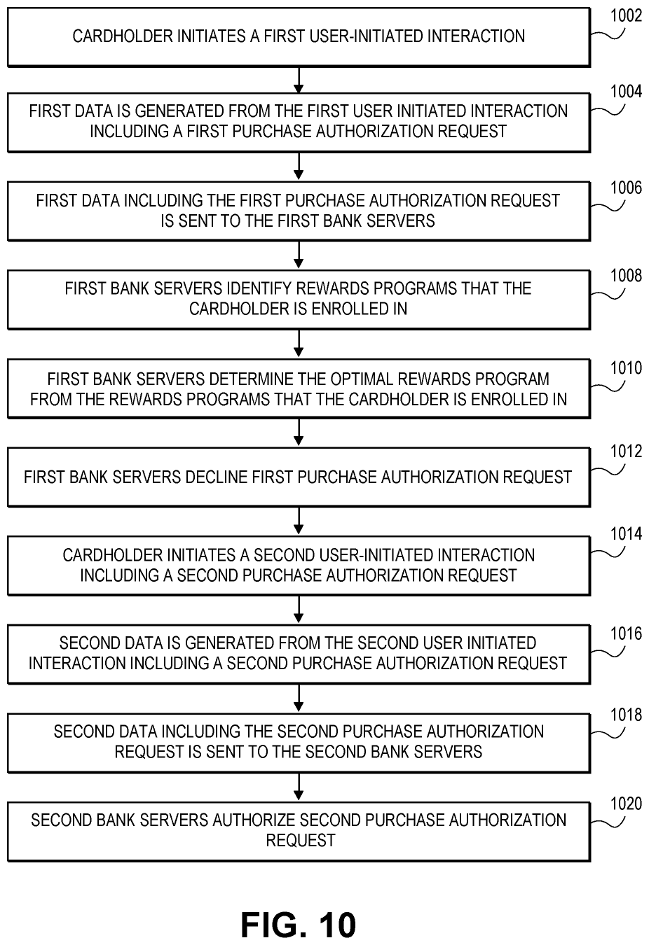

FIG. 10 illustrates an example diagram for performing an example method of completing a purchase with an optimal rewards program via one user-initiated interaction. The example flow diagram may begin at block 1002 when the cardholder 101 initiates a first interaction to purchase one or more items from the merchant 130. As discussed above, the interaction may be initiated by any suitable technique, such as by initiating an interaction between a physical bank card 102 and a bank card machine 132. In some embodiments, the bank card is a physical bank card including an EMV chip. In some embodiments, the bank card is comprised in an electronic wallet (e.g., the bank card is a virtual card). Alternately, the interaction may be for an online purchase, and thus initiated via a website of the merchant 130 (e.g., via one or more merchant processors 140).

At block 1004, the first user-initiated interaction may generate (e.g., by the bank card machine 132) first data including (i) identification data identifying a cardholder of the bank card, (ii) a first purchase authorization request to purchase one or more items from a merchant, and/or (iii) merchant identification data. The first data may then be sent to one or more processors (e.g., of the first bank 150, the second bank 160, the merchant servers 140, and/or the cellular network 610, etc.). At block 1006, the one or more processors receives the first data.

At block 1008 the one or more processors identify rewards programs that the cardholder 101 is enrolled in. For example, the one or more processors may create or identify a list of rewards programs that the cardholder 101 is enrolled in.

At block 1010, the one or more processors determine an optimal rewards program. In some embodiments, the one or more processors determines the optimal rewards program by: determining a rewards value in currency associated with the first purchase authorization request to purchase the one or more items from the merchant for a first rewards program of the plurality of rewards programs; determining a rewards value in points associated with the first purchase authorization request to purchase the one or more items from the merchant for a second rewards program of the plurality of rewards programs; converting the rewards value in points of the second rewards program to an equivalent currency value of the second rewards program; and comparing the rewards value in currency of the first rewards program with the equivalent currency value of the second rewards program to determine the optimal rewards program. Furthermore, the mobile device 103 may send, to the one or more processors, a desired points-to-currency conversion rate; and the converting the rewards value in points of the second rewards program to the equivalent currency value of the second rewards program may be done based on the received desired points-to-currency conversion rate.

In some embodiments, the optimal rewards program is determined by: determining a rewards value associated with the first purchase authorization request to purchase the one or more items from the merchant for a first rewards program of the plurality of rewards programs; determining a rewards value associated with the first purchase authorization request to purchase the one or more items from the merchant for a second rewards program of the plurality of rewards programs; and comparing the rewards value of the first rewards program with the rewards value of the second rewards program to determine the optimal rewards program.

In some embodiments, the first purchase authorization request includes a transaction description. In some variations, the method further comprises: receiving, with the one or more processors, data of labeled transaction descriptions mapping transaction descriptions to merchants; determining, with the one or more processors, an identity of the merchant based on: (i) the transaction description included in the first purchase authorization request, and (ii) the data of labeled transaction descriptions; and determining a type of merchant based on the determined identity of the merchant; the determining the rewards value for the first rewards program is based on the determined type of merchant. In some embodiments, the determining the rewards value for the second rewards program is based on the determined type of merchant.

In some implementations, the first purchase authorization request includes a transaction description. In some variations, the method further comprises: receiving, with the one or more processors, regular expression (regex) data mapping transaction descriptions to merchants; determining, with the one or more processors, an identity of the merchant based on: (i) the transaction description included in the first purchase authorization request, and (ii) the regrex data; and determining a type of merchant based on the determined identity of the merchant; the determining the rewards value for the first rewards program is based on the determined type of merchant. In some embodiments, the determining the rewards value for the second rewards program is based on the determined type of merchant.

In some aspects, it is advantageous to determine the optimal rewards program (e.g., at block 1010) based on the identity of the merchant 130. To this end, some embodiments leverage geolocation data to determine the identity of the merchant 130. As such, in some embodiments, the method further comprises: receiving, with the one or more processors, global positioning system (GPS) data from a mobile device of the cardholder; determining, with the one or more processors, an identity of the merchant by cross referencing the received GPS data with geographical data; and determining, with the one or more processors, a type of the merchant based on the identity of the merchant. In some embodiments, the determining the rewards value for the first rewards program is based on the determined type of merchant; and the determining the rewards value for the second rewards program is based on the determined type of merchant.

Further to this end, in some embodiments, the method further comprises: receiving, with the one or more processors, first signal data of a mobile device of the cardholder, wherein the first signal data was measured by a first base station; receiving, with the one or more processors, second signal data of the mobile device of the cardholder, wherein the second signal data was measured by a second base station; receiving, with the one or more processors, third signal data of the mobile device of the cardholder, wherein the third signal data was measured by a third base station; determining, with the one or more processors, a location of the mobile device of the cardholder by applying a triangulation technique to the first signal data, the second signal data, and the third signal data; determining, with the one or more processors, an identity of the merchant by cross referencing the determined location with geographical data; and determining, with the one or more processors, a type of the merchant based on the identity of the merchant. In some embodiments, the determining the rewards value for the first rewards program is based on the determined type of merchant; and the determining the rewards value for the second rewards program is based on the determined type of merchant.

Still further to this end, in some embodiments, the method further comprises: receiving, with a beacon, a Bluetooth communication from a mobile device of the cardholder; sending data of the Bluetooth communication from the beacon to the one or more processors; receiving, with the one or more processors, geographical data of a plurality of beacons; determining, with the one or more processors, an identity of the merchant by applying the data of the Bluetooth communication to the geographical data; and determining, with the one or more processors, a type of the merchant based on the merchant identity. In some embodiments, the determining the rewards value for the first rewards program is based on the determined type of merchant; and the determining the rewards value for the second rewards program is based on the determined type of merchant.

Still further to this end, in some embodiments, the method further comprises: receiving, with a WiFi access point, a WiFi communication from a mobile device of the cardholder; sending data of the WiFi communication from the WiFi access point to the one or more processors; receiving, with the one or more processors, geographical data of a plurality of WiFi access points; determining, with the one or more processors, an identity of the merchant by applying the data of the WiFi communication to the geographical data; and determining, with the one or more processors, a type of the merchant based on the identity of the merchant. In some embodiments, the determining the rewards value for the first rewards program is based on the determined type of merchant; and the determining the rewards value for the second rewards program is based on the determined type of merchant.

Still further to this end, in some embodiments where the purchase is made online, the merchant identity may be made based on the website of the merchant. As such, in some embodiments, the method further comprises: receiving, with the one or more processors, merchant identification data from the website of the merchant; and determining, with the one or more processors, a type of the merchant from the merchant identification data. In some variations of this, the first purchase authorization request includes a transaction description, and additional transaction information, the additional transaction information including: (i) a transaction amount, (ii) a merchant category code (MCC), and (iii) a merchant address; and the method further comprises determining an identity of the merchant by applying the transaction description and the additional transaction information to a machine learning algorithm comprising a neural network.

To even further improve the determination of the optimal rewards program at block 1010, the method may further include: the determining the rewards value associated with the first purchase authorization request to purchase the one or more items from the merchant for the first rewards program is done according to a minimum spend requirement of the first rewards program; and the determining the rewards value associated with the first purchase authorization request to purchase the one or more items from the merchant for the second rewards program is done according to a minimum spend requirement of the second rewards program.

In some embodiments, to even further improve the determination of the optimal rewards program: the first purchase authorization request includes a transaction description, and additional transaction information, the additional transaction information including: (i) a transaction amount, (ii) a merchant category code (MCC), and/or (iii) a merchant address; and the method further comprises determining, with the one or more processors, an identity of the merchant by applying the transaction description and the additional transaction information to a machine learning algorithm. In some implementations, the additional transaction information includes all of: (i) the transaction amount, (ii) the MCC, and (iii) the merchant address; and the machine learning algorithm is a neural network.

In some implementations, the optimal rewards program is determined by: sending, to a first rewards program of the plurality of rewards programs and to a second rewards program of the plurality of rewards programs: (i) the identification data identifying a cardholder of the bank card, and (ii) the first purchase authorization request to purchase the one or more items from the merchant; receiving a bid from the first rewards program and a bid from the second rewards program; and comparing the bid from the first rewards program and the bid from the second rewards program to determine the optimal rewards program.

In some embodiments, the optimal rewards program is determined by: receiving, from a mobile device of the cardholder, a preference for using a first rewards program of the plurality of rewards programs when a purchase is from a particular merchant; and determining the optimal rewards program according to the preference.

In some embodiments, the optimal rewards program is determined by: receiving, from a mobile device of the cardholder, a preference for using a first rewards program of the plurality of rewards programs when a purchase is from a particular merchant; receiving, from the mobile device of the cardholder, a default preference for using a second rewards program of the plurality of rewards programs; determining that the merchant of the first purchase authorization request to purchase the one or more items from is not the particular merchant; and in response to the determination that the merchant of the first purchase authorization request to purchase the one or more items from is not the particular merchant, determining that the optimal rewards program is the second rewards program.

In some embodiments, the optimal rewards program is determined by: receiving, from a mobile device of the cardholder, a preference for using a first rewards program of the plurality of rewards programs for a particular category of purchases; and determining the optimal rewards program according to the preference.

At block 1012, the one or more processors declines the first purchase authorization request. At block 1014, the cardholder 101 initiates a second user-initiated interaction.

At block 1016, second data is generated (e.g., by the bank card machine 132) from the second user initiated interaction including a second purchase authorization request. At block 1018, the second data including the second purchase authorization request is sent to the second bank servers 160. At block 1020, the second bank servers authorize second purchase authorization request.

It should be appreciated that other embodiments may include additional, fewer, or alternative functions to those described with respect to FIG. 10. For example, functions described with respect to the other flow diagrams and/or signal diagrams described herein may be combined with the functions described with respect to the flow diagram of FIG. 10.

### Example Implementation—Completing a Purchase Via Two User-Initiated Interactions

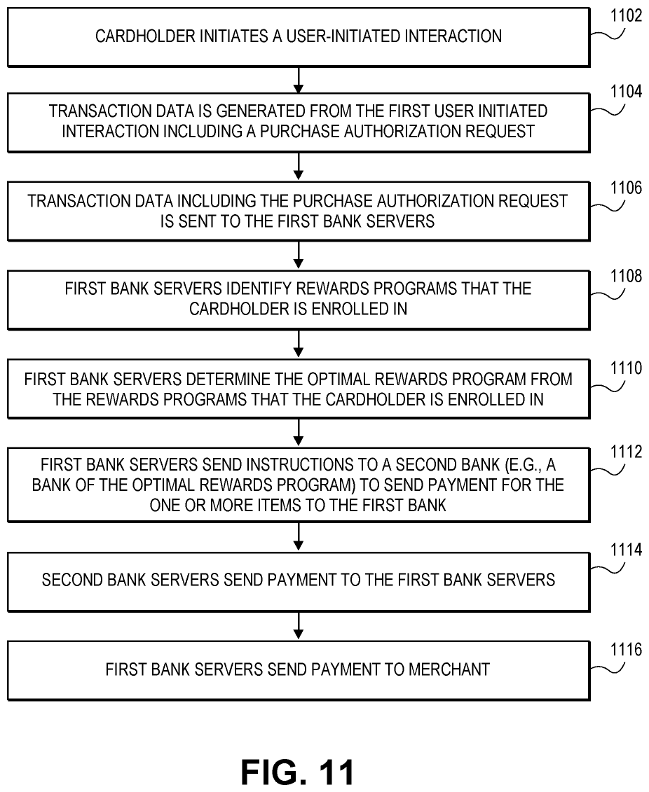

FIG. 11 illustrates an example diagram for an example method of completing a purchase with an optimal rewards program via two user-initiated interactions. The example flow diagram may begin at block 1102 when the cardholder 101 initiates an interaction to purchase one or more items from the merchant 130. As discussed above, the interaction may be initiated by any suitable technique, such as by initiating an interaction between a physical bank card 102 and a bank card machine 132. In some embodiments, the bank card is a physical bank card including an EMV chip. In some embodiments, the bank card is comprised in an electronic wallet (e.g., the bank card is a virtual card). Alternately, the interaction may be for an online purchase, and thus initiated via a website of the merchant 130 (e.g., via one or more merchant processors 140).

At block 1104, the user-initiated interaction may generate (e.g., by the bank card machine 132) transaction data including (i) identification data identifying a cardholder of the bank card, (ii) a purchase authorization request to purchase one or more items from a merchant, and/or (iii) merchant identification data. The transaction data may then be sent to one or more processors (e.g., of the first bank 150, the second bank 160, the merchant servers 140, and/or the cellular network 610, etc.). At block 1106, the one or more processors receives the transaction data.

At block 1108 the one or more processors identify rewards programs that the cardholder 101 is enrolled in. For example, the one or more processors may create or identify a list of rewards programs that the cardholder 101 is enrolled in.

At block 1110, the one or more processors determine an optimal rewards program.

In some aspects, it is advantageous to determine the optimal rewards program (e.g., at block 1110) based on the identity of the merchant 130. To this end, some embodiments leverage geolocation data to determine the identity of the merchant 130. As such, in some embodiments, the method further comprises: receiving, with the one or more processors of the first bank, global positioning system (GPS) data from a mobile device of the cardholder; determining, with the one or more processors of the first bank, an identity of the merchant by cross referencing the received GPS data with geographical data; and determining the optimal rewards program based on the identity of the merchant.

Further to this end, in some embodiments, the method further comprises: receiving, with the one or more processors of the first bank, first signal data of a mobile device of the cardholder, wherein the first signal data was measured by a first base station; receiving, with the one or more processors of the first bank, second signal data of the mobile device of the cardholder, wherein the second signal data was measured by a second base station; receiving, with the one or more processors, third signal data of the mobile device of the cardholder, wherein the third signal data was measured by a third base station; determining, with the one or more processors, a location of the mobile device of the cardholder by applying a triangulation technique to the first signal data, the second signal data, and the third signal data; determining, with the one or more processors of the first bank, an identity of the merchant by cross referencing the determined location with geographical data; and the determining the optimal rewards program based on the identity of the merchant.

Still further to this end, in some embodiments, the method further comprises: receiving, with a beacon, a Bluetooth communication from a mobile device of the cardholder; sending data of the Bluetooth communication from the beacon to the one or more processors of the first bank; receiving, with the one or more processors of the first bank, geographical data of a plurality of beacons, determining, with the one or more processors of the first bank, an identity of the merchant by applying the data of the Bluetooth communication to the geographical data; and determining the optimal rewards program based on the identity of the merchant.

Still further to this end, in some embodiments, the method further comprises: receiving, with a WiFi access point, a WiFi communication from a mobile device of the cardholder; sending data of the WiFi communication from the WiFi access point to the one or more processors of the first bank; receiving, with the one or more processors of the first bank, geographical data of a plurality of WiFi access points, and determining, with the one or more processors of the first bank, an identity of the merchant by applying the data of the WiFi communication to the geographical data; and determining the optimal rewards program based on the identity of the merchant.

Still further to this end, in some embodiments where the purchase is made online, the merchant identity may be made based on the website of the merchant. As such, in some embodiments, the method further comprises: receiving, with the one or more processors of the first bank, merchant identification data from the website of the merchant; determining, with the one or more processors of the first bank, a type of the merchant from the merchant identification data. In some embodiments, the determining of the optimal rewards program is based on the determined type of merchant. In some variations of this, the purchase authorization request includes a transaction description, and additional transaction information, the additional transaction information including: (i) a transaction amount, (ii) a merchant category code (MCC), and (iii) a merchant address; and the method further comprises determining, with the one or more processors of the first bank, an identity of the merchant by applying the transaction description and the additional transaction information to a machine learning algorithm comprising a neural network.

At block 1112, the first bank servers 150 send instructions to a second bank (e.g., a bank of the optimal rewards program) to send payment (e.g., via EFT) for the one or more items to the first bank. However, in some embodiments, the first bank servers 150 will only send the instructions if it is determined that the purchase should be authorized. Thus, in some embodiments, the method further comprises: prior to the sending of the instructions to the second bank, authorizing, with the one or more processors of the first bank, the purchase authorization request to purchase the one or more items from the merchant.

At block 1114, in response to the received instructions, the second bank servers 160 send payment to the first bank servers 150. In this regard, in some embodiments, the method further comprises: receiving, with the one or more processors of the first bank, the payment for the one or more items from the second bank.

However, in some embodiments, the second bank authorizes the purchase authorization request. In this regard, in some embodiments, the method further comprises: receiving, with one or more processors of the second bank, the instructions to send payment; with the one or more processors of the second bank, in response to receiving the instructions, determining whether to authorize the purchase authorization request; determining, with the one or more processors of the second bank, to authorize the purchase authorization request; and with the one or more processors of the second bank, in response to the determining to authorize the purchase authorization request, sending, to the one or more processors of the first bank: (i) money to purchase the one or more items, and (ii) authorization of the purchase of the one or more items.

At block 1116, the first bank servers 1116 send payment to the merchant 130 (e.g., to merchant servers 140). In this regard, in some embodiments, the method further comprises: sending, via the one or more processors of the first bank, the payment for the one or more items from the first bank to a bank of the merchant.

It should be appreciated that other embodiments may include additional, fewer, or alternative functions to those described with respect to FIG. 11. For example, functions described with respect to the other flow diagrams and/or signal diagrams described herein may be combined with the functions described with respect to the flow diagram of FIG. 11.

### Other Matters

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

### Exemplary Embodiments

Aspect 1. A computer-implemented method, comprising:

receiving, with one or more processors, first data generated from a first user-initiated interaction between a bank card and a bank card processing machine, the first data including: (i) identification data identifying a cardholder of the bank card, and (ii) a first purchase authorization request to purchase one or more items from a merchant;

identifying, with the one or more processors, based on the identification data, a plurality of rewards programs that the cardholder is enrolled in;

determining, with the one or more processors, an optimal rewards program of the plurality of rewards programs for the purchase of the one or more items;

declining, with the one or more processors, the first purchase authorization request to purchase the one or more items from the merchant;

receiving, with the one or more processors, second data generated from a second user-initiated interaction between the bank card and the bank card processing machine, the second data including a second purchase authorization request to purchase the one or more items from the merchant; and

completing, with the one or more processors, a purchase of the one or more items from the merchant by applying a payment method associated with the determined optimal rewards program to the second purchase authorization request to purchase the one or more items from the merchant.

Aspect 2. The method of aspect 1, further comprising determining the optimal rewards program by:

determining, with the one or more processors, a rewards value in currency associated with the first purchase authorization request to purchase the one or more items from the merchant for a first rewards program of the plurality of rewards programs;

determining, with the one or more processors, a rewards value in points associated with the first purchase authorization request to purchase the one or more items from the merchant for a second rewards program of the plurality of rewards programs;

converting, with the one or more processors, the rewards value in points of the second rewards program to an equivalent currency value of the second rewards program; and

comparing, with the one or more processors, the rewards value in currency of the first rewards program with the equivalent currency value of the second rewards program to determine the optimal rewards program.

Aspect 3. The method of any one of aspects 1-2, further comprising:

receiving, with the one or more processors, a desired points-to-currency conversion rate from the cardholder; and

converting, with the one or more processors, the rewards value in points of the second rewards program to the equivalent currency value of the second rewards program based on the received desired points-to-currency conversion rate.

Aspect 4. The method of any one of aspects 1-3, further comprising:

determining the optimal rewards program by:

determining, with the one or more processors, a rewards value associated with the first purchase authorization request to purchase the one or more items from the merchant for a first rewards program of the plurality of rewards programs;

determining, with the one or more processors, a rewards value associated with the first purchase authorization request to purchase the one or more items from the merchant for a second rewards program of the plurality of rewards programs; and

comparing, with the one or more processors, the rewards value of the first rewards program with the rewards value of the second rewards program to determine the optimal rewards program.

Aspect 5. The method of any one of aspects 1-4, further comprising:

receiving, with the one or more processors, the first data further including (iii) merchant identification data;

determining, with the one or more processors, a type of merchant based on the merchant identification data;

determining, with the one or more processors, the rewards value for the first rewards program based on the determined type of merchant; and

determining, with the one or more processors, the rewards value for the second rewards program based on the determined type of merchant.

Aspect 6. The method of any one of aspects 1-5, further comprising:

receiving, with the one or more processors, the first purchase authorization request including a transaction description;

receiving, with the one or more processors, data of labeled transaction descriptions mapping transaction descriptions to merchants;

determining, with the one or more processors, an identity of the merchant based on: (i) the transaction description included in the first purchase authorization request, and (ii) the data of labeled transaction descriptions;

determining, with the one or more processors, a type of merchant based on the determined identity of the merchant;

determining, with the one or more processors, the rewards value for the first rewards program is based on the determined type of merchant; and

determining, with the one or more processors, the rewards value for the second rewards program is based on the determined type of merchant.

Aspect 7. The method of any one of aspects 1-6, further comprising:

receiving, with the one or more processors, the first purchase authorization request including a transaction description;

receiving, with the one or more processors, regular expression (regex) data mapping transaction descriptions to merchants;

determining, with the one or more processors, an identity of the merchant based on: (i) the transaction description included in the first purchase authorization request, and (ii) the regrex data;

determining, with the one or more processors, a type of merchant based on the determined identity of the merchant;

determining, with the one or more processors, the rewards value for the first rewards program is based on the determined type of merchant; and

determining, with the one or more processors, the rewards value for the second rewards program is based on the determined type of merchant.

Aspect 8. The method of any one of aspects 1-7, further comprising:

receiving, with the one or more processors, global positioning system (GPS) data from a mobile device of the cardholder;

determining, with the one or more processors, an identity of the merchant by cross referencing the received GPS data with geographical data;

determining, with the one or more processors, a type of the merchant based on the identity of the merchant;

determining, with the one or more processors, the rewards value for the first rewards program is based on the determined type of merchant; and

determining, with the one or more processors, the rewards value for the second rewards program is based on the determined type of merchant.

Aspect 9. The method of any one of aspects 1-8, further comprising:

receiving, with the one or more processors, first signal data of a mobile device of the cardholder, wherein the first signal data was measured by a first base station;

receiving, with the one or more processors, second signal data of the mobile device of the cardholder, wherein the second signal data was measured by a second base station;

receiving, with the one or more processors, third signal data of the mobile device of the cardholder, wherein the third signal data was measured by a third base station;

determining, with the one or more processors, a location of the mobile device of the cardholder by applying a triangulation technique to the first signal data, the second signal data, and the third signal data;

determining, with the one or more processors, an identity of the merchant by cross referencing the determined location with geographical data;

determining, with the one or more processors, a type of the merchant based on the identity of the merchant;

determining, with the one or more processors, the rewards value for the first rewards program is based on the determined type of merchant; and

determining, with the one or more processors, the rewards value for the second rewards program is based on the determined type of merchant.

Aspect 10. The method of any one of aspects 1-9, further comprising:

receiving, with a beacon, a Bluetooth communication from a mobile device of the cardholder;

sending data of the Bluetooth communication from the beacon to the one or more processors;

receiving, with the one or more processors, geographical data of a plurality of beacons;

determining, with the one or more processors, an identity of the merchant by applying the data of the Bluetooth communication to the geographical data;

determining, with the one or more processors, a type of the merchant based on the merchant identity;

determining, with the one or more processors, the rewards value for the first rewards program is based on the determined type of merchant; and

determining, with the one or more processors, the rewards value for the second rewards program is based on the determined type of merchant.

Aspect 11. The method of any one of aspects 1-10, further comprising:

receiving, with a WiFi access point, a WiFi communication from a mobile device of the cardholder;

sending data of the WiFi communication from the WiFi access point to the one or more processors;

receiving, with the one or more processors, geographical data of a plurality of WiFi access points;

determining, with the one or more processors, an identity of the merchant by applying the data of the WiFi communication to the geographical data;

determining, with the one or more processors, a type of the merchant based on the identity of the merchant;

determining, with the one or more processors, the rewards value for the first rewards program is based on the determined type of merchant; and

determining, with the one or more processors, the rewards value for the second rewards program is based on the determined type of merchant.

Aspect 12. The method of any one of aspects 1-11, further comprising:

determining, with the one or more processors, the rewards value associated with the first purchase authorization request to purchase the one or more items from the merchant for the first rewards program according to a minimum spend requirement of the first rewards program; and

determining, with the one or more processors, the rewards value associated with the first purchase authorization request to purchase the one or more items from the merchant for the second rewards program according to a minimum spend requirement of the second rewards program.

Aspect 13. The method of any one of aspects 1-12, further comprising:

receiving, with the one or more processors, the first purchase authorization request, the first purchase authorization request including a transaction description, and additional transaction information, the additional transaction information including: (i) a transaction amount, (ii) a merchant category code (MCC), and/or (iii) a merchant address; and

determining, with the one or more processors, an identity of the merchant by applying the transaction description and the additional transaction information to a machine learning algorithm.

Aspect 14. The method of aspect 13, further comprising:

receiving, with the one or more processors, the additional transaction information, the additional transaction information including all of: (i) the transaction amount, (ii) the MCC, and (iii) the merchant address; and

applying, with the one or more processors, the transaction description and the additional transaction information to the machine learning algorithm comprising a neural network.

Aspect 15. The method of any one of aspects 1-14, further comprising determining the optimal rewards program by:

sending, with the one or more processors, to a first rewards program of the plurality of rewards programs and to a second rewards program of the plurality of rewards programs: (i) the identification data identifying a cardholder of the bank card, and (ii) the first purchase authorization request to purchase the one or more items from the merchant;

receiving, with the one or more processors, a bid from the first rewards program and a bid from the second rewards program; and

comparing, with the one or more processors, the bid from the first rewards program and the bid from the second rewards program to determine the optimal rewards program.

Aspect 16. The method of any one of aspects 1-15, further comprising determining the optimal rewards program by:

receiving, with the one or more processors, from a mobile device of the cardholder, a preference for using a first rewards program of the plurality of rewards programs when a purchase is from a particular merchant; and

determining, with the one or more processors, the optimal rewards program according to the preference.

Aspect 17. The method of any one of aspects 1-16, further comprising determining the optimal rewards program by:

receiving, with the one or more processors and from a mobile device of the cardholder, a preference for using a first rewards program of the plurality of rewards programs when a purchase is from a particular merchant;

receiving, with the one or more processors and from the mobile device of the cardholder, a default preference for using a second rewards program of the plurality of rewards programs;

determining, with the one or more processors, that the merchant of the first purchase authorization request to purchase the one or more items from is not the particular merchant; and

in response to the determination that the merchant of the first purchase authorization request to purchase the one or more items from is not the particular merchant, determining, with the one or more processors, that the optimal rewards program is the second rewards program.

Aspect 18. The method of any one of aspects 1-17, further comprising determining the optimal rewards program by:

receiving, with the one or more processors and from a mobile device of the cardholder, a preference for using a first rewards program of the plurality of rewards programs for a particular category of purchases; and

determining, with the one or more processors, the optimal rewards program according to the preference.

Aspect 19. The method of any one of aspects 1-18, the bank card being a physical bank card including a microchip.

Aspect 20. The method of any one of aspects 1-18, the bank card being comprised in an electronic wallet.

Aspect 21. A computer-implemented method, comprising:

receiving, with one or more processors, first data generated from a first user-initiated interaction between a bank card and one or more merchant processors, the first data including: (i) identification data identifying a cardholder of the bank card, and (ii) a first purchase authorization request to purchase one or more items from a merchant;

identifying, with the one or more processors, based on the identification data, a plurality of rewards programs that the cardholder is enrolled in;

determining, with the one or more processors, an optimal rewards program of the plurality of rewards programs for the purchase of the one or more items;

declining, with the one or more processors, the first purchase authorization request to purchase the one or more items from the merchant;

receiving, with the one or more processors, second data generated from a second user-initiated interaction between the bank card and the one or more bank card processors, the second data including a second purchase authorization request to purchase the one or more items from the merchant; and

completing, with the one or more processors, a purchase of the one or more items from the merchant by applying a payment method associated with the determined optimal rewards program to the second purchase authorization request to purchase the one or more items from the merchant.

Aspect 22. The method of aspect 21, further comprising:

initiating, with the one or more processors, the first and second user-initiated interactions between the bank card and the one or more merchant processors occur through a website of the merchant; receiving, with the one or more processors, merchant identification data from the website of the merchant;

determining, with the one or more processors, a type of the merchant from the merchant identification data; and

determining of the optimal rewards program based on the determined type of merchant.

Aspect 23. The method of any one of aspects 21-22, further including:

receiving, with the one or more processors, the first purchase authorization request, the first purchase authorization request including a transaction description, and additional transaction information, the additional transaction information including: (i) a transaction amount, (ii) a merchant category code (MCC), and (iii) a merchant address; and

determining, with the one or more processors, an identity of the merchant by applying the transaction description and the additional transaction information to a machine learning algorithm comprising a neural network.

Aspect 24. A computer-implemented method, comprising:

receiving, with one or more processors of a first bank, transaction data generated from a user-initiated interaction between a bank card and a bank card processing machine, the transaction data including: (i) identification data identifying a cardholder of the bank card, and (ii) a purchase authorization request to purchase one or more items from a merchant;

identifying, with the one or more processors of the first bank, based on the identification data, a plurality of rewards programs that the cardholder is enrolled in;

determining, with the one or more processors of the first bank, an optimal rewards program of the plurality of rewards programs for the purchase of the one or more items; and

sending, with the one or more processors of the first bank, instructions to a second bank to send payment for the one or more items to the first bank, the second bank being a bank of the optimal rewards program.

Aspect 25. The method of aspect 24, further comprising:

receiving, with the one or more processors of the first bank, the payment for the one or more items from the second bank; and

sending, via the one or more processors of the first bank, the payment for the one or more items from the first bank to a bank of the merchant.

Aspect 26. The method of any one of aspects 24-25, further comprising, prior to the sending of the instructions to the second bank:

authorizing, with the one or more processors of the first bank, the purchase authorization request to purchase the one or more items from the merchant.

Aspect 27. The method of any one of aspects 24-26, further comprising:

receiving, with one or more processors of the second bank, the instructions to send payment;

with the one or more processors of the second bank, in response to receiving the instructions, determining whether to authorize the purchase authorization request;

determining, with the one or more processors of the second bank, to authorize the purchase authorization request; and

with the one or more processors of the second bank, in response to the determining to authorize the purchase authorization request, sending, to the one or more processors of the first bank: (i) money to purchase the one or more items, and (ii) authorization of the purchase of the one or more items.

Aspect 28. The method of any one of aspects 24-27, further comprising:

receiving, with the one or more processors of the first bank, global positioning system (GPS) data from a mobile device of the cardholder;

determining, with the one or more processors of the first bank, an identity of the merchant by cross referencing the received GPS data with geographical data; and

determining, with the one or more processors of the first bank, the optimal rewards program based on the identity of the merchant.

Aspect 29. The method of any one of aspects 24-28, further comprising:

receiving, with the one or more processors of the first bank, first signal data of a mobile device of the cardholder, wherein the first signal data was measured by a first base station;

receiving, with the one or more processors of the first bank, second signal data of the mobile device of the cardholder, wherein the second signal data was measured by a second base station;

receiving, with the one or more processors, third signal data of the mobile device of the cardholder, wherein the third signal data was measured by a third base station;

determining, with the one or more processors, a location of the mobile device of the cardholder by applying a triangulation technique to the first signal data, the second signal data, and the third signal data;

determining, with the one or more processors of the first bank, an identity of the merchant by cross referencing the determined location with geographical data; and

determining, with the one or more processors of the first bank, the optimal rewards program based on the identity of the merchant.

Aspect 30. The method of any one of aspects 24-29, further comprising:

receiving, with a beacon, a Bluetooth communication from a mobile device of the cardholder;

sending data of the Bluetooth communication from the beacon to the one or more processors of the first bank;

receiving, with the one or more processors of the first bank, geographical data of a plurality of beacons,

determining, with the one or more processors of the first bank, an identity of the merchant by applying the data of the Bluetooth communication to the geographical data; and

determining, with the one or more processors of the first bank, the optimal rewards program based on the identity of the merchant.

Aspect 31. The method of any one of aspects 24-30, further comprising:

receiving, with a WiFi access point, a WiFi communication from a mobile device of the cardholder;

sending data of the WiFi communication from the WiFi access point to the one or more processors of the first bank;

receiving, with the one or more processors of the first bank, geographical data of a plurality of WiFi access points,

determining, with the one or more processors of the first bank, an identity of the merchant by applying the data of the WiFi communication to the geographical data; and

determining, with the one or more processors of the first bank, the optimal rewards program based on the identity of the merchant.

Aspect 32. The method of aspect 24, the user-initiated interaction between a bank card and a bank card processing machine being initiated via near field communication (NFC).

Aspect 33. A computer-implemented method, comprising:

receiving, with one or more processors of a first bank, transaction data generated from a user-initiated interaction between a bank card and one or more merchant processors, the transaction data including: (i) identification data identifying a cardholder of the bank card, and (ii) a purchase authorization request to purchase one or more items from a merchant;

identifying, with the one or more processors of the first bank, based on the identification data, a plurality of rewards programs that the cardholder is enrolled in;

determining, with the one or more processors of the first bank, an optimal rewards program of the plurality of rewards programs for the purchase of the one or more items;

authorizing, with the one or more processors of the first bank, the request to purchase the one or more items from the merchant; and

instructing, with the one or more processors of the first bank, a second bank to send payment for the one or more items to the first bank, the second bank being a bank of the optimal rewards program.

Aspect 34. The method of aspect 33, further comprising:

initiating, with the one or more processors of the first bank, the user-initiated interaction between the bank card and the one or more merchant processors occurs through a website of the merchant; receiving, with the one or more processors of the first bank, merchant identification data from the website of the merchant;

determining, with the one or more processors of the first bank, a type of the merchant from the merchant identification data; and

determining, with the one or more processors of the first bank, the optimal rewards program based on the determined type of merchant.

Aspect 35. The method of any one of aspects 32-34, further comprising:

receiving, with the one or more processors of the first bank, the purchase authorization request, the purchase authorization request including a transaction description, and additional transaction information, the additional transaction information including: (i) a transaction amount, (ii) a merchant category code (MCC), and (iii) a merchant address; and

determining, with the one or more processors of the first bank, an identity of the merchant by applying the transaction description and the additional transaction information to a machine learning algorithm comprising a neural network.

36. A computer-implemented method, comprising:

receiving, with one or more processors of a browser extension, transaction data generated from a user-initiated interaction between a bank card and one or more merchant processors, the transaction data including: (i) identification data identifying a cardholder of the bank card, and (ii) a purchase authorization request to purchase one or more items from a merchant;

identifying, with the one or more processors of the browser extension, based on the identification data, a plurality of rewards programs that the cardholder is enrolled in;

determining, with the one or more processors of the browser extension, an optimal rewards program of the plurality of rewards programs for the purchase of the one or more items;

in response to the determination of the optimal rewards program by the one or more processors of the browser extension, sending, from the one or more processors of the browser extension to one or more processors of a second bank, the transaction data including the identification data and the purchase authorization request.

Aspect 37. A system, comprising:

a bank card processing machine configured to interact with a bank card to process a transaction; and

one or more processors configured to:

receive first data generated from a first user-initiated interaction between the bank card and the bank card processing machine, the first data including: (i) identification data identifying a cardholder of the bank card, and (ii) a first purchase authorization request to purchase one or more items from a merchant;

identify, based on the identification data, a plurality of rewards programs that the cardholder is enrolled in;

determine an optimal rewards program of the plurality of rewards programs for the purchase of the one or more items;

decline the first purchase authorization request to purchase the one or more items from the merchant;

receive second data generated from a second user-initiated interaction between the bank card and the bank card processing machine, the second data including a second purchase authorization request to purchase the one or more items from the merchant; and

complete a purchase of the one or more items from the merchant by applying a payment method associated with the determined optimal rewards program to the second purchase authorization request to purchase the one or more items from the merchant.

1. A computer-implemented method, comprising:
receiving, with a first set of one or more processors, first data generated from a first user-initiated interaction between a bank card and a bank card processing machine, the first data including: (i) identification data identifying a cardholder of the bank card, and (ii) a first purchase authorization request to purchase one or more items from a merchant;
identifying, with the first set of one or more processors, based on the identification data, a plurality of rewards programs that the cardholder is enrolled in;
determining, with the first set of one or more processors, an optimal rewards program of the plurality of rewards programs for the purchase of the one or more items, the optimal rewards program corresponding to an entity;
declining, with the first set of one or more processors, the first purchase authorization request to purchase the one or more items from the merchant by sending information indicating the determined optimal rewards program along with an instruction to decline the first purchase authorization request to the bank card processing machine;
sending, from the bank card processing machine to a second set of one or more processors associated with the entity, and according to the information indicating the optimal rewards program second data generated from a second user-initiated interaction between the bank card and the bank card processing machine, the second data including a second purchase authorization request to purchase the one or more items from the merchant; and
completing, with the second set of one or more processors, a purchase of the one or more items from the merchant by: (i) applying a payment method associated with the determined optimal rewards program to the second purchase authorization request to purchase the one or more items from the merchant, and (ii) initiating an electronic funds transfer to a merchant server of the merchant.

2. The method of claim 1, further comprising determining the optimal rewards program by:
determining, with the first set of one or more processors, a rewards value in currency associated with the first purchase authorization request to purchase the one or more items from the merchant for a first rewards program of the plurality of rewards programs;
determining, with the first set of one or more processors, a rewards value in points associated with the first purchase authorization request to purchase the one or more items from the merchant for a second rewards program of the plurality of rewards programs;
converting, with the first set of one or more processors, the rewards value in points of the second rewards program to an equivalent currency value of the second rewards program; and
comparing, with the first set of one or more processors, the rewards value in currency of the first rewards program with the equivalent currency value of the second rewards program to determine the optimal rewards program.

3. The method of claim 2, further comprising:
receiving, with the first set of one or more processors, a desired points-to-currency conversion rate from the cardholder; and
converting, with the first set of one or more processors, the rewards value in points of the second rewards program to the equivalent currency value of the second rewards program based on the received desired points-to-currency conversion rate.

4. The method of claim 1, further comprising:
determining the optimal rewards program by:
determining, with the first set of one or more processors, a rewards value associated with the first purchase authorization request to purchase the one or more items from the merchant for a first rewards program of the plurality of rewards programs;
determining, with the first set of one or more processors, a rewards value associated with the first purchase authorization request to purchase the one or more items from the merchant for a second rewards program of the plurality of rewards programs; and
comparing, with the first set of one or more processors, the rewards value of the first rewards program with the rewards value of the second rewards program to determine the optimal rewards program.

5. The method of claim 4, further comprising:
receiving, with the first set of one or more processors, the first data further including (iii) merchant identification data;
determining, with the first set of one or more processors, a type of merchant based on the merchant identification data;
determining, with the first set of one or more processors, the rewards value for the first rewards program based on the determined type of merchant; and
determining, with the first set of one or more processors, the rewards value for the second rewards program based on the determined type of merchant.

6. The method of claim 4, further comprising:
receiving, with the first set of one or more processors, the first purchase authorization request including a transaction description;
receiving, with the first set of one or more processors, data of labeled transaction descriptions mapping transaction descriptions to merchants;
determining, with the first set of one or more processors, an identity of the merchant based on: (i) the transaction description included in the first purchase authorization request, and (ii) the data of labeled transaction descriptions;
determining, with the first set of one or more processors, a type of merchant based on the determined identity of the merchant;
determining, with the first set of one or more processors, the rewards value for the first rewards program based on the determined type of merchant; and
determining, with the first set of one or more processors, the rewards value for the second rewards program based on the determined type of merchant.

7. The method of claim 4, further comprising:
receiving, with the first set of one or more processors, the first purchase authorization request including a transaction description;
receiving, with the first set of one or more processors, regular expression (regex) data mapping transaction descriptions to merchants;
determining, with the first set of one or more processors, an identity of the merchant based on: (i) the transaction description included in the first purchase authorization request, and (ii) the regrex data;
determining, with the first set of one or more processors, a type of merchant based on the determined identity of the merchant;
determining, with the first set of one or more processors, the rewards value for the first rewards program based on the determined type of merchant; and
determining, with the first set of one or more processors, the rewards value for the second rewards program based on the determined type of merchant.

8. The method of claim 4, further comprising:
receiving, with the first set of one or more processors, global positioning system (GPS) data from a mobile device of the cardholder;
determining, with the first set of one or more processors, an identity of the merchant by cross referencing the received GPS data with geographical data;
determining, with the first set of one or more processors, a type of the merchant based on the identity of the merchant;
determining, with the first set of one or more processors, the rewards value for the first rewards program based on the determined type of merchant; and
determining, with the first set of one or more processors, the rewards value for the second rewards program based on the determined type of merchant.

9. The method of claim 4, further comprising:
receiving, with the first set of one or more processors, first signal data of a mobile device of the cardholder, wherein the first signal data was measured by a first base station;
receiving, with the first set of one or more processors, second signal data of the mobile device of the cardholder, wherein the second signal data was measured by a second base station;
receiving, with the first set of one or more processors, third signal data of the mobile device of the cardholder, wherein the third signal data was measured by a third base station;
determining, with the first set of one or more processors, a location of the mobile device of the cardholder by applying a triangulation technique to the first signal data, the second signal data, and the third signal data;
determining, with the first set of one or more processors, an identity of the merchant by cross referencing the determined location with geographical data;
determining, with the first set of one or more processors, a type of the merchant based on the identity of the merchant;
determining, with the first set of one or more processors, the rewards value for the first rewards program based on the determined type of merchant; and
determining, with the first set of one or more processors, the rewards value for the second rewards program based on the determined type of merchant.

10. The method of claim 4, further comprising:
receiving, with a beacon, a Bluetooth communication from a mobile device of the cardholder;
sending data of the Bluetooth communication from the beacon to the first set of one or more processors;
receiving, with the first set of one or more processors, geographical data of a plurality of beacons;
determining, with the first set of one or more processors, an identity of the merchant by applying the data of the Bluetooth communication to the geographical data;
determining, with the first set of one or more processors, a type of the merchant based on the merchant identity;
determining, with the first set of one or more processors, the rewards value for the first rewards program based on the determined type of merchant; and
determining, with the first set of one or more processors, the rewards value for the second rewards program based on the determined type of merchant.

11. The method of claim 4, further comprising:
receiving, with a WiFi access point, a WiFi communication from a mobile device of the cardholder;
sending data of the WiFi communication from the WiFi access point to the first set of one or more processors;
receiving, with the one or more processors, geographical data of a plurality of WiFi access points;
determining, with the first set of one or more processors, an identity of the merchant by applying the data of the WiFi communication to the geographical data;
determining, with the first set of one or more processors, a type of the merchant based on the identity of the merchant;
determining, with the first set of one or more processors, the rewards value for the first rewards program based on the determined type of merchant; and
determining, with the first set of one or more processors, the rewards value for the second rewards program based on the determined type of merchant.

12. The method of claim 4, further comprising:
determining, with the first set of one or more processors, the rewards value associated with the first purchase authorization request to purchase the one or more items from the merchant for the first rewards program according to a minimum spend requirement of the first rewards program; and
determining, with the first set of one or more processors, the rewards value associated with the first purchase authorization request to purchase the one or more items from the merchant for the second rewards program according to a minimum spend requirement of the second rewards program.

13. The method of claim 1, further comprising:
receiving, with the first set of one or more processors, the first purchase authorization request, the first purchase authorization request including a transaction description, and additional transaction information, the additional transaction information including: (i) a transaction amount, (ii) a merchant category code (MCC), and/or (iii) a merchant address; and
determining, with the first set of one or more processors, an identity of the merchant by applying the transaction description and the additional transaction information to a machine learning algorithm.

14. The method of claim 13, further comprising:
receiving, with the first set of one or more processors, the additional transaction information, the additional transaction information including all of: (i) the transaction amount, (ii) the MCC, and (iii) the merchant address; and
applying, with the first set of one or more processors, the transaction description and the additional transaction information to the machine learning algorithm comprising a neural network.

15. The method of claim 1, further comprising determining the optimal rewards program by:
sending, with the first set of one or more processors, to a first rewards program of the plurality of rewards programs and to a second rewards program of the plurality of rewards programs: (i) the identification data identifying a cardholder of the bank card, and (ii) the first purchase authorization request to purchase the one or more items from the merchant;
receiving, with the first set of one or more processors, a bid from the first rewards program and a bid from the second rewards program; and
comparing, with the first set of one or more processors, the bid from the first rewards program and the bid from the second rewards program to determine the optimal rewards program.

16. The method of claim 1, further comprising determining the optimal rewards program by:
receiving, with the first set of one or more processors and from a mobile device of the cardholder, a preference for using a first rewards program of the plurality of rewards programs when a purchase is from a particular merchant; and
determining, with the first set of one or more processors, the optimal rewards program according to the preference.

17. The method of claim 1, further comprising determining the optimal rewards program by:
receiving, with the first set of one or more processors and from a mobile device of the cardholder, a preference for using a first rewards program of the plurality of rewards programs when a purchase is from a particular merchant;
receiving, with the first set of one or more processors and from the mobile device of the cardholder, a default preference for using a second rewards program of the plurality of rewards programs;
determining, with the first set of one or more processors, that the merchant of the first purchase authorization request to purchase the one or more items from is not the particular merchant; and
in response to the determination that the merchant of the first purchase authorization request to purchase the one or more items from is not the particular merchant, determining, with the first set of one or more processors, that the optimal rewards program is the second rewards program.

18. The method of claim 1, further comprising determining the optimal rewards program by:
receiving, with the first set of one or more processors and from a mobile device of the cardholder, a preference for using a first rewards program of the plurality of rewards programs for a particular category of purchases; and
determining, with the first set of one or more processors, the optimal rewards program according to the preference.

19. The method of claim 1, the bank card being a physical bank card including a microchip.

20. The method of claim 1, the bank card being comprised in an electronic wallet.

21. A computer-implemented method, comprising:
receiving, with a first set of one or more processors, first data generated from a first user-initiated interaction between a bank card and one or more merchant processors, the first data including: (i) identification data identifying a cardholder of the bank card, and (ii) a first purchase authorization request to purchase one or more items from a merchant;
identifying, with the first set of one or more processors, based on the identification data, a plurality of rewards programs that the cardholder is enrolled in;
determining, with the first set of one or more processors, an optimal rewards program of the plurality of rewards programs for the purchase of the one or more items, the optimal rewards program corresponding to an entity;
declining, with the first set of one or more processors, the first purchase authorization request to purchase the one or more items from the merchant by sending information indicating the determined optimal rewards program along with an instruction to decline the first purchase authorization request to the one or more merchant processors;
sending, from the one or more merchant processors to a second set of one or more processors associated with the entity, and according to the information indicating the optimal rewards program second data generated from a second user-initiated interaction between the bank card and the one or more merchant processors, the second data including a second purchase authorization request to purchase the one or more items from the merchant; and
completing, with the second set of one or more processors, a purchase of the one or more items from the merchant by: (i) applying a payment method associated with the determined optimal rewards program to the second purchase authorization request to purchase the one or more items from the merchant, and (ii) initiating an electronic funds transfer to a merchant server of the merchant.

22. The method of claim 21, further comprising:
initiating, with the first set of one or more processors, the first and second user-initiated interactions between the bank card and the one or more merchant processors through a website of the merchant;
receiving, with the first set of one or more processors, merchant identification data from the website of the merchant; and
determining, with the first set of one or more processors, a type of the merchant from the merchant identification data; and
wherein the determining the optimal rewards program comprises determining the optimal rewards program based on the determined type of merchant.

23. The method of claim 21, further including:
receiving, with the first set of one or more processors, the first purchase authorization request, the first purchase authorization request including a transaction description, and additional transaction information, the additional transaction information including: (i) a transaction amount, (ii) a merchant category code (MCC), and (iii) a merchant address; and
determining, with the first set of one or more processors, an identity of the merchant by applying the transaction description and the additional transaction information to a machine learning algorithm comprising a neural network.

24. A computer-implemented method, comprising:
receiving, with one or more processors of a first bank, transaction data generated from a user-initiated interaction between a bank card and a bank card processing machine, the transaction data including: (i) identification data identifying a cardholder of the bank card, and (ii) a purchase authorization request to purchase one or more items from a merchant;
identifying, with the one or more processors of the first bank, based on the identification data, a plurality of rewards programs that the cardholder is enrolled in;
determining, with the one or more processors of the first bank, an optimal rewards program of the plurality of rewards programs for the purchase of the one or more items; and
sending, with the one or more processors of the first bank, instructions to a second bank to send payment for the one or more items to the first bank, the second bank being a bank of the optimal rewards program.

25. The method of claim 24, further comprising:
receiving, with the one or more processors of the first bank, the payment for the one or more items from the second bank; and
sending, via the one or more processors of the first bank, the payment for the one or more items from the first bank to a bank of the merchant.

26. The method of claim 24, further comprising, prior to the sending of the instructions to the second bank:
authorizing, with the one or more processors of the first bank, the purchase authorization request to purchase the one or more items from the merchant.

27. The method of claim 24, further comprising:
receiving, with one or more processors of the second bank, the instructions to send payment;
with the one or more processors of the second bank, in response to receiving the instructions, determining whether to authorize the purchase authorization request; and
determining, with the one or more processors of the second bank, to authorize the purchase authorization request; and
with the one or more processors of the second bank, in response to the determining to authorize the purchase authorization request, sending, to the one or more processors of the first bank: (i) money to purchase the one or more items, and (ii) authorization of the purchase of the one or more items.

28. The method of claim 24, further comprising:
receiving, with the one or more processors of the first bank, global positioning system (GPS) data from a mobile device of the cardholder;
determining, with the one or more processors of the first bank, an identity of the merchant by cross referencing the received GPS data with geographical data; and
determining, with the one or more processors of the first bank, the optimal rewards program based on the identity of the merchant.

29. The method of claim 24, further comprising:
receiving, with the one or more processors of the first bank, first signal data of a mobile device of the cardholder, wherein the first signal data was measured by a first base station;
receiving, with the one or more processors of the first bank, second signal data of the mobile device of the cardholder, wherein the second signal data was measured by a second base station;
receiving, with the one or more processors, third signal data of the mobile device of the cardholder, wherein the third signal data was measured by a third base station;
determining, with the one or more processors, a location of the mobile device of the cardholder by applying a triangulation technique to the first signal data, the second signal data, and the third signal data;
determining, with the one or more processors of the first bank, an identity of the merchant by cross referencing the determined location with geographical data; and
determining, with the one or more processors of the first bank, the optimal rewards program based on the identity of the merchant.

30-37. (canceled)

38. A system, comprising:
a bank card processing machine configured to interact with a bank card to process a transaction; and
a first set of one or more processors configured to:
receive first data generated from a first user-initiated interaction between the bank card and the bank card processing machine, the first data including: (i) identification data identifying a cardholder of the bank card, and (ii) a first purchase authorization request to purchase one or more items from a merchant;
identify, based on the identification data, a plurality of rewards programs that the cardholder is enrolled in;
determine an optimal rewards program of the plurality of rewards programs for the purchase of the one or more items, the optimal rewards program corresponding to a second set of one or more processors; and
decline the first purchase authorization request to purchase the one or more items from the merchant by sending information indicating the determined optimal rewards program along with an instruction to decline the first purchase authorization request to the bank card processing machine; and
wherein the bank card processing machine is further configured to send, according to the information indicating the optimal rewards program, second data generated from a second user-initiated interaction between the bank card and the bank card processing machine, the second data including a second purchase authorization request to purchase the one or more items from the merchant; and
wherein the system further includes the second set of one or more processors, and wherein the second set of one or more processors are configured to:
complete a purchase of the one or more items from the merchant by: (i) applying a payment method associated with the determined optimal rewards program to the second purchase authorization request to purchase the one or more items from the merchant, and (ii) initiating an electronic funds transfer to a merchant server of the merchant.
